(19) United States
(12) Patent Application Publication
(10) Pub. No.: US 2026/0362020 A1
(43) Pub. Date: Nov. 12, 2026

(54) SEAMLESS REAL-TIME BAYER DOMAIN VIDEO COMPOSITING

(71) Applicant: Intel Products IP LLC, Santa Clara, CA (US)

(72) Inventors: Rony Zatzarinni, Tel Aviv (IL); Hava Matichin, Petah Tikva (IL); Dor Barber, Herzliya (IL); Moran Klein, Ra’anana (IL); Chaim Gross, Jerusalem (IL)

(73) Assignee: Intel Products IP LLC, Santa Clara, CA (US)

(21) Appl. No.: 19/722,756

(22) Filed: Jun. 27, 2026

(51) Int. Cl. H04N 23/84; H04N 23/81; H04N 23/88

(52) U.S. Cl. CPC H04N 23/843; H04N 23/81; H04N 23/88

(57) ABSTRACT

Systems, apparatuses, and methods for raw-domain video compositing are described. In an example, content data is conditioned, before image signal processing of a captured frame by an image signal processor, to generate conditioned raw content data. The conditioned raw content data is composited with raw image data to generate composite raw image data, and the composite raw image data is processed by an image signal processing pipeline of the image signal processor. In some examples, the raw image data includes mosaiced raw image data, and the compositing is performed before demosaicing. Conditioning the content data may include modifying the content data based on one or more parameters associated with capture or image signal processing, applying an inverse image-processing operation, adding sensor-consistent noise, or a combination thereof. The content data may correspond to graphical object data, background replacement data, inpainted region data, or outpainted region data.

### BACKGROUND

Cameras are optical systems that capture and record light to create images. A camera can include components such as lenses, sensors, and processing units that process the signals captured by the sensors.

Digital cameras commonly include an image sensor that generates image data based on incident light received from a scene. The image data generated by the image sensor may be processed by one or more image processing components to produce an image or a sequence of images, such as a video stream. Such processing may include operations that modify color, brightness, detail, noise, or other characteristics of the captured image data.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates an imaging system having raw domain video compositing, according to some examples of the disclosure.

FIG. 2 illustrates implementations of compositing, according to some examples of the disclosure.

FIG. 3 illustrates implementations of conditioning, according to some examples of the disclosure.

FIG. 4 illustrates implementations of a micro-pipe, according to some examples of the disclosure.

FIG. 5 is a flowchart illustrating a method for inserting a logo or graphic, according to some examples of the disclosure.

FIG. 6 is a flowchart illustrating a method for content removal and inpainting, according to some examples of the disclosure.

FIG. 7 is a flowchart illustrating a method for outpainting, according to some examples of the disclosure.

FIG. 8 is a flowchart illustrating a method for image processing, according to some examples of the disclosure.

FIG. 9 is a block diagram of an example computing device, according to some examples of the disclosure.

### DETAILED DESCRIPTION

### Overview

An imaging system can include a sensor, and an image processing unit that processes the signals captured by the sensor. The sensor may capture a raw image, and the image processing unit may receive the raw image and produce a processed image. Image processing units may perform various operations on image data generated by the sensor.

In some imaging systems, it can be desirable to add, replace, synthesize, or extend visual content in a captured image or video frame. For example, content data may comprise graphical object data, logo data, virtual object data, background replacement data, inpainted region data, outpainted region data, or a combination thereof. The content data may be associated with a target region of a captured frame, such as a region defined by one or more of coordinates, a bounding box, a mask, a segmentation map, an object marking, and a border region of an output frame.

When content data is combined with image data after image signal processing, the added or replacement content may be processed differently from captured-image pixels of the frame. This can produce differences in color reproduction, detail reproduction, spatial noise characteristics, temporal noise behavior, and responsiveness to changing capture conditions. These differences may be especially visible in video because exposure, gain, white balance, tone mapping, and temporal noise reduction can vary across frames.

The techniques described herein condition content data before image signal processing of a captured frame by an image signal processor to generate conditioned raw content data. The conditioned raw content data is composited with raw image data to generate composite raw image data. The composite raw image data is then processed by an image signal processing pipeline of the image signal processor. Processing the composite raw image data in this manner allows captured-image pixels and pixels corresponding to the conditioned raw content data to be processed by a common image signal processing pipeline.

In some examples, the raw image data comprises mosaiced raw image data, and compositing the conditioned raw content data with the raw image data is performed before demosaicing of the captured frame. By performing composition in a raw sensor domain before demosaicing, white balance, color correction, denoising, sharpening, tone mapping, and related processing, the content region can be introduced at a stage of the pipeline that is compatible with the captured sensor data. This allows later image signal processing operations to operate on the content pixels and captured-image pixels in a coordinated manner.

Conditioning the content data may comprise modifying the content data based on one or more parameters associated with capture or image signal processing of the captured frame. For example, the one or more parameters may comprise one or more of a white-balance parameter, a color-correction parameter, an exposure parameter, an analog gain, a digital gain, a black-level parameter, a sensor-noise parameter, and an image signal processor tuning parameter. Parameter-based conditioning allows the content data to be adapted to the state of the sensor, camera controller, image signal processor, or camera pipeline for a particular frame or sequence of frames.

In some examples, conditioning the content data comprises applying, to the content data, an inverse of at least one image-processing operation to be applied by the image signal processing pipeline. The inverse of the at least one image-processing operation may comprise one or more of an inverse white-balance operation and an inverse color-correction-matrix operation. Applying such inverse processing can prepare the content data so that, after the image signal processing pipeline applies its normal operations, the content has a desired appearance in the processed image without being visually over-corrected relative to the captured scene.

In some examples, conditioning the content data comprises adding sensor-consistent noise to the content data before compositing the conditioned raw content data with the raw image data. The sensor-consistent noise may be generated based on a physical noise model of the image sensor that captured the frame. The physical noise model may comprise one or more of an intensity-dependent noise component and a read-noise component. Noise generation may be based on gain, exposure, black level, sensor calibration data, or sensor-noise parameters, allowing the content data to have spatial and temporal noise characteristics that more closely correspond to the captured raw image data.

The target region for compositing may be static or dynamic. In some examples, the target region is determined based on a reduced-resolution image generated from the raw image data by a processing path that operates in parallel with the image signal processing pipeline. The processing path may comprise a micro-pipe. Using the reduced-resolution image, the system may track one or more of motion of a surface, an object, a face, a body portion, and a foreground subject across a plurality of frames. This allows conditioned raw content data to remain aligned with a moving region while reducing the computational cost associated with full-resolution tracking.

The image signal processing pipeline may apply temporal noise reduction to both captured-image pixels of the composite raw image data and pixels corresponding to the conditioned raw content data. Because temporal noise reduction can depend on information across multiple frames, applying temporal noise reduction after raw-domain compositing can improve temporal coherence between the content region and the captured-image region. This can reduce visual artifacts such as clean inserted content, frozen noise, flickering noise, or content that changes differently from adjacent captured pixels.

The conditioned raw content data need not be generated from content data having the same format as the raw image data. In some examples, the content data may be received in a processed image domain, a linear image domain, a graphics domain, a generated-content domain, or a stored asset domain, and may be converted, mapped, or adjusted to generate conditioned raw content data for composition with raw image data. In this manner, the same raw-domain compositing architecture can support content from different content sources while allowing the image signal processing pipeline to process the resulting composite raw image data.

The conditioning of the content data may be performed as a single operation or as a sequence of operations. In some examples, the conditioning may comprise one or more of color-related conditioning, noise-related conditioning, spatial conditioning, format conversion, mosaicing, mask generation, alpha generation, boundary adjustment, and temporal adjustment. Different subsets of these operations may be used for different types of content data or different target regions. For example, graphical object data may be conditioned using inverse color processing and sensor-consistent noise, while inpainted region data or outpainted region data may be conditioned using sensor-consistent noise, gain-based adjustment, exposure-based adjustment, or raw-domain format conversion.

The compositing may occur at any suitable point before completion of image signal processing for a captured frame. In some examples, the conditioned raw content data is composited with raw image data before one or more of demosaicing, white balance, color correction, tone mapping, denoising, temporal noise reduction, sharpening, and output formatting. Performing the compositing before one or more of these operations allows the image signal processing pipeline to apply a common processing behavior to captured-image pixels and pixels corresponding to the conditioned raw content data.

The raw image data, the conditioned raw content data, and the composite raw image data may each represent a full frame, a portion of a frame, a tile, a line group, a block, or another image-data unit processed by an imaging system. In some examples, the conditioned raw content data is generated only for a target region and composited with a corresponding portion of the raw image data. Such regional processing can reduce memory bandwidth, processing latency, and power consumption while maintaining compatibility with an image signal processing pipeline that processes the composite raw image data.

The image processing system may obtain information for conditioning the content data from different sources within a camera pipeline. In some examples, the information is obtained from one or more of sensor metadata, image sensor registers, a camera controller, a three-A controller, an image signal processor, an image-quality tuning database, calibration data, frame metadata, and memory storing camera-state information. Using such information allows the conditioned raw content data to reflect a current capture state or image-processing state of the captured frame.

The target region into which the conditioned raw content data is composited may be generated by an internal component of the imaging system or received from an external component. In some examples, the target region is generated based on object detection, face detection, body detection, segmentation, motion estimation, user input, application-layer instructions, content-placement metadata, or a target output format. This allows the same raw-domain conditioning and compositing process to support static content placement, dynamic content placement, background replacement, object removal, and output-frame expansion.

In some examples, the image signal processor processes the composite raw image data without distinguishing between pixels originally captured by the image sensor and pixels corresponding to the conditioned raw content data. In other examples, metadata, masks, or region identifiers associated with the conditioned raw content data may be provided to the image signal processor to guide one or more image signal processing operations. This allows the architecture to support both transparent insertion of conditioned raw content data into the raw image data and region-aware processing of the composite raw image data.

The techniques may be implemented at different levels of an imaging stack. In some examples, the conditioning and compositing are performed by a camera subsystem before the composite raw image data is provided to an image signal processor. In some examples, the conditioning and compositing are performed by circuitry integrated with, coupled to, or upstream of the image signal processor. In some examples, the conditioning and compositing are performed by software or firmware executing on a host processor, graphics processor, neural processing unit, programmable accelerator, fixed-function circuit, or a combination thereof.

The described techniques can be implemented using one or more processing circuits. For example, conditioning the content data and compositing the conditioned raw content data with the raw image data may be performed by one or more of a central processing unit, a graphics processing unit, a programmable accelerator, a neural processing unit, and fixed-function circuitry. The techniques may be used in cameras, mobile devices, laptop computers, conferencing systems, augmented-reality systems, edge devices, and image processing systems that process real-time video.

By generating conditioned raw content data and compositing the conditioned raw content data with raw image data before image signal processing, the imaging system can use existing image signal processing operations to harmonize captured and content-derived portions of a frame. This can improve color consistency, detail consistency, spatial noise consistency, temporal noise behavior, latency, power efficiency, and robustness to changing capture conditions.

As used herein, “raw image data” can refer to image data generated by an image sensor before at least one image signal processing operation is applied to the image data. Raw image data may comprise mosaiced raw image data, Bayer-pattern image data, non-demosaiced image data, image data in a raw sensor domain, or image data derived from sensor output before demosaicing.

As used herein, “content data” can refer to data representing content to be inserted into, substituted for, generated for, or used to extend a captured frame. Content data may comprise one or more of graphical object data, logo data, virtual object data, background replacement data, inpainted region data, and outpainted region data.

As used herein, “conditioned raw content data” can refer to content data that has been processed, converted, modified, generated, or adjusted for composition with raw image data. Conditioned raw content data may comprise content data that has been modified based on one or more parameters associated with capture or image signal processing of a captured frame, converted into a raw sensor domain, mosaiced, resized, warped, inverse processed, noise conditioned, or any combination thereof.

As used herein, “conditioning” content data can refer to processing, converting, modifying, generating, or adjusting content data to generate conditioned raw content data. Conditioning may comprise one or more of applying an inverse image-processing operation, applying an inverse white-balance operation, applying an inverse color-correction-matrix operation, adding sensor-consistent noise, modifying content data based on capture parameters, modifying content data based on image signal processing parameters, resizing content data, warping content data, and converting content data into a raw sensor domain.

As used herein, “parameters associated with capture or image signal processing” can refer to parameters associated with acquisition of a captured frame, processing of the captured frame, or a state of an image processing pipeline. The parameters may comprise one or more of a white-balance parameter, a color-correction parameter, an exposure parameter, an analog gain, a digital gain, a black-level parameter, a sensor-noise parameter, an image signal processor tuning parameter, a tone-mapping parameter, a denoising parameter, and a camera-control parameter.

As used herein, “sensor-consistent noise” can refer to noise generated or applied to content data to correspond to noise associated with an image sensor that captured a frame. Sensor-consistent noise may be based on one or more of a physical noise model, an intensity-dependent noise component, a read-noise component, a shot-noise component, a gain value, an exposure value, a black-level value, sensor calibration data, and a sensor-noise parameter.

As used herein, “target region” can refer to a region of raw image data, a captured frame, or an output frame into which conditioned raw content data is composited. A target region may be defined by one or more of coordinates, a bounding box, a mask, a segmentation map, an object marking, a detected object region, a tracked object region, a foreground region, a background region, and a border region of an output frame.

As used herein, “composite raw image data” can refer to raw image data generated by compositing conditioned raw content data with raw image data. Composite raw image data may comprise raw image data in which pixels of a target region are overwritten, blended, alpha blended, mask blended, replaced, synthesized, extended, or supplemented using conditioned raw content data.

As used herein, “image signal processing pipeline” can refer to one or more image processing operations applied to raw image data or composite raw image data by an image signal processor. The image signal processing pipeline may comprise one or more of demosaicing, white balance, color correction, denoising, temporal noise reduction, spatial noise reduction, sharpening, detail processing, tone mapping, gamma correction, color-space conversion, scaling, and output formatting.

As used herein, “processing path” can refer to a hardware, software, firmware, or hybrid path for processing image data. A processing path may operate in parallel with an image signal processing pipeline and may generate a reduced-resolution image from raw image data. In some examples, the processing path comprises a micro-pipe used to generate a reduced-resolution image for determining a target region.

As used herein, “micro-pipe” can refer to a reduced-complexity image processing path that processes raw image data to generate a reduced-resolution image, preview image, proxy image, or processed image for analysis. The micro-pipe may be used for one or more of tracking, detection, segmentation, motion estimation, target-region determination, and coordinate generation.

As used herein, “inpainted region data” can refer to content data generated to replace, reconstruct, remove, or synthesize a region of a captured frame. Inpainted region data may be generated based on one or more of surrounding image data, a mask, an object marking, a segmentation map, a classical image-processing algorithm, a neural network, a generative model, and a diffusion model.

As used herein, “outpainted region data” can refer to content data generated to extend a captured frame beyond a region captured by, selected from, or used from raw image data. Outpainted region data may correspond to one or more border regions of an output frame and may be used to generate an output frame having a target aspect ratio, field of view, or frame boundary.

### Raw-Domain Video Compositing Architecture

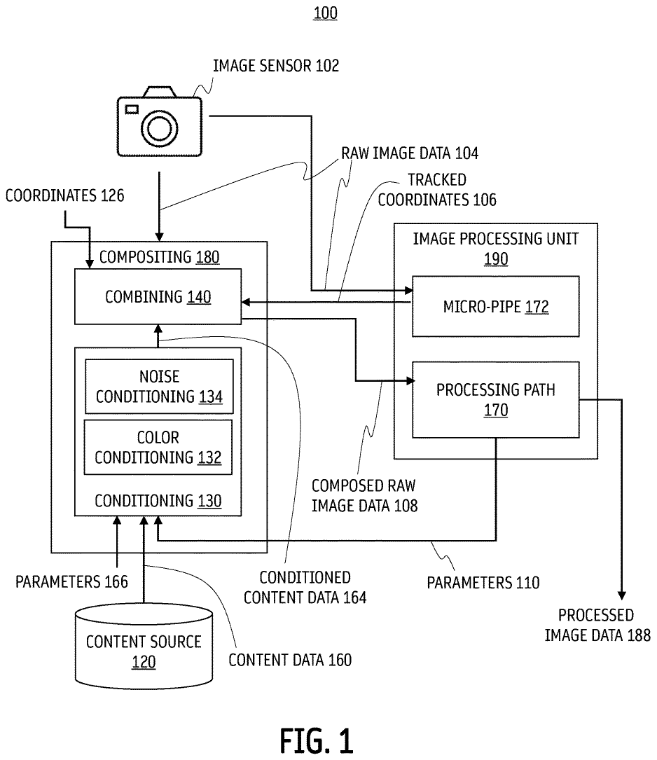

FIG. 1 illustrates imaging system 100 having raw domain video compositing, according to some examples of the disclosure. Imaging system 100 can comprise image sensor 102, content source 120, compositing 180, and image processing unit 190. Imaging system 100 can generate composite raw image data 108 by conditioning content data 160 to generate conditioned content data 164 and combining conditioned content data 164 with raw image data 104 before at least one image signal processing operation is performed by image processing unit 190. In some examples, composite raw image data 108 may also be referred to as composite raw image data.

Image sensor 102 can capture light from a scene and generate raw image data 104. Raw image data 104 can comprise image data generated by image sensor 102 before at least one image signal processing operation is applied to raw image data 104. In some examples, raw image data 104 can comprise mosaiced raw image data, Bayer-pattern image data, non-demosaiced image data, image data in a raw sensor domain, or image data derived from sensor output before demosaicing. Processing raw image data 104 before demosaicing can allow content to be introduced into a frame at a stage that is compatible with sensor-originated pixels.

Content source 120 can provide content data 160 to compositing 180. Content source 120 can comprise a source, memory, store, buffer, register, database, storage device, or repository that stores or provides content data 160. Content data 160 can represent content to be inserted into, substituted for, generated for, or used to extend a captured frame. In some examples, content data 160 can comprise one or more of graphical object data, logo data, virtual object data, background replacement data, inpainted region data, and outpainted region data. Content data 160 may be generated, selected, or modified by one or more components before being stored in or provided by content source 120. For example, one or more of a graphics processor, a generative model, an inpainting module, an outpainting module, an application processor, a host application, and processing circuitry may generate, select, or modify content data 160 for composition with raw image data 104.

In some examples, content data 160 comprises background replacement data. Conditioning 130 may condition the background replacement data before image signal processing of a captured frame by image processing unit 190, and combining 140 may composite conditioned background replacement data with raw image data 104 in a background target region. In some examples, the background target region is determined based on one or more of a foreground mask, a background mask, a person segmentation map, a depth map, a detected subject region, and application-layer background replacement information. By conditioning background replacement data before downstream image signal processing, image processing unit 190 can apply common color processing, detail processing, noise processing, and temporal noise reduction to both captured-image pixels and pixels corresponding to the background replacement data.

In some examples, conditioning background replacement data rather than modifying a foreground subject can preserve an intended appearance of the foreground subject. For example, background replacement data may be modified based on one or more parameters associated with capture or image signal processing of the captured frame so that the replacement background is processed consistently with captured foreground pixels. This can reduce a need to alter colors, brightness, texture, noise, or detail of a person or foreground object to match a replacement background, and can help maintain the captured appearance of the foreground subject while making the replacement background appear less synthetic.

Compositing 180 can comprise conditioning 130 and combining 140. Conditioning 130 can condition content data 160, before image signal processing by image processing unit 190, to generate conditioned content data 164. In some examples, conditioned content data 164 can comprise conditioned raw content data suitable for composition with raw image data 104. Conditioning 130 can process, convert, modify, generate, or adjust content data 160 so that conditioned content data 164 is compatible with a raw sensor domain, a mosaiced image format, a current capture state, a current image signal processing state, or a combination thereof.

Conditioning 130 can comprise color conditioning 132 and noise conditioning 134. Color conditioning 132 can modify content data 160 based on one or more color-related operations to be applied by image processing unit 190. In some examples, color conditioning 132 can reflect, compensate for, or complement one or more color-related operations of processing path 170 so that conditioned content data 164 is suitable for composition with raw image data 104 before processing by image processing unit 190. The one or more color-related operations of processing path 170 may vary among implementations and may comprise one or more of white-balance correction, partial white-balance correction, color-correction-matrix processing, color-space conversion, tone mapping, gamma correction, local color processing, and image signal processor tuning.

In some examples, color conditioning 132 comprises applying, to content data 160, an inverse of at least one color-related image-processing operation to be applied by processing path 170. For example, color conditioning 132 may comprise one or more of an inverse white-balance operation, an inverse partial white-balance operation, an inverse color-correction-matrix operation, an inverse tone-mapping operation, an inverse gamma operation, and an inverse color-space conversion operation. By reflecting the color-related operations to be applied by processing path 170, color conditioning 132 can cause conditioned content data 164 to have a desired appearance after composite raw image data 108 is processed by image processing unit 190.

Noise conditioning 134 can add sensor-consistent noise to content data 160 before conditioned content data 164 is combined with raw image data 104. Sensor-consistent noise can be generated based on a physical noise model of image sensor 102. In some examples, the physical noise model can comprise one or more of an intensity-dependent noise component and a read-noise component. Noise conditioning 134 may generate noise based on one or more of exposure, analog gain, digital gain, black level, sensor calibration data, and sensor-noise parameters. Adding sensor-consistent noise before image processing can allow pixels corresponding to conditioned content data 164 to exhibit spatial noise and temporal noise behavior that more closely corresponds to captured-image pixels after image processing.

Combining 140 can composite conditioned content data 164 with raw image data 104 to generate composite raw image data 108. Combining 140 can receive coordinates 126, tracked coordinates 106, or both, and can use coordinates 126 or tracked coordinates 106 to identify a target region of raw image data 104 for composition. The target region can be defined by one or more of coordinates, tracked coordinates, a bounding box, a mask, a segmentation map, an object marking, and a border region of an output frame. Combining 140 can composite conditioned content data 164 into the target region using one or more of pixel replacement, pixel overwriting, alpha blending, mask-based blending, segmentation-based compositing, border-region synthesis, and regional substitution.

Image processing unit 190 can receive composite raw image data 108 from compositing 180 and generate processed image data 188. Image processing unit 190 can comprise processing path 170 and micro-pipe 172. Processing path 170 can apply one or more image signal processing operations to composite raw image data 108. In some examples, processing path 170 can comprise an image signal processing pipeline that applies one or more of demosaicing, white balance, color correction, denoising, temporal noise reduction, spatial noise reduction, sharpening, detail processing, tone mapping, gamma correction, color-space conversion, scaling, and output formatting. Processing composite raw image data 108 allows processing path 170 to apply common processing to captured-image pixels and pixels corresponding to conditioned content data 164.

In some examples, micro-pipe 172 can process raw image data 104 to generate information used to determine tracked coordinates 106. In some examples, micro-pipe 172 can operate in parallel with processing path 170 and can generate a reduced-resolution image from raw image data 104. Tracked coordinates 106 can be determined based on the reduced-resolution image. For example, micro-pipe 172 may support tracking of one or more of motion of a surface, an object, a face, a body portion, and a foreground subject across a plurality of frames. Using micro-pipe 172 to support target-region determination can reduce processing cost, memory bandwidth, latency, and power consumption relative to full-resolution tracking while allowing conditioned content data 164 to remain aligned with moving image content.

Parameters 110 can be provided from image processing unit 190 to compositing 180. Parameters 110 can comprise information associated with a current state of image processing unit 190, image sensor 102, or imaging system 100. In some examples, parameters 110 can comprise one or more of white-balance gains, a color-correction matrix, exposure time, analog gain, digital gain, black level, sensor-noise parameters, tuning parameters, tone-mapping parameters, denoising parameters, and camera-control parameters. Providing parameters 110 to compositing 180 can allow conditioning 130 to generate conditioned content data 164 that reflects capture and processing conditions for the frame being processed.

Parameters used by conditioning 130 may be obtained from different portions of imaging system 100. In some examples, parameters 110, parameters 166, or both, may be obtained from one or more of image processing unit 190, a camera controller, a three-A controller, image sensor metadata, image sensor registers, frame metadata, memory storing camera-state information, a sensor calibration database, an image-quality tuning database, and an image-quality tuning tool. For example, sensor-noise parameters, black-level parameters, gain-dependent coefficients, or tuning parameters may be generated during sensor calibration or image-quality tuning and may be provided to noise conditioning 134 for generating sensor-consistent noise.

In some examples, image processing unit 190 applies temporal noise reduction to both captured-image pixels of composite raw image data 108 and pixels corresponding to conditioned content data 164. Because conditioned content data 164 is combined with raw image data 104 before processing path 170 generates processed image data 188, temporal noise reduction and related image signal processing operations can be applied to content-derived pixels and sensor-derived pixels in a coordinated manner. This can improve color consistency, detail consistency, spatial noise consistency, temporal noise consistency, latency, power efficiency, and robustness to changing capture conditions.

In FIG. 1, one or more illustrated components, data paths, and operations may be optional, combined, omitted, or implemented in a different arrangement. For example, although conditioning 130 is shown as comprising color conditioning 132 and noise conditioning 134, conditioning 130 need not perform both color conditioning 132 and noise conditioning 134 in every implementation. In some examples, conditioning 130 may perform color conditioning 132 without noise conditioning 134, noise conditioning 134 without color conditioning 132, format conversion without color conditioning 132 or noise conditioning 134, spatial adjustment, mosaicing, resizing, warping, alpha generation, mask generation, or any combination thereof.

In some examples, the particular color-related operations performed by color conditioning 132 may depend on the color-related operations implemented by processing path 170. For example, color conditioning 132 may apply inverse white-balance processing when processing path 170 applies white-balance processing, inverse color-correction-matrix processing when processing path 170 applies color-correction-matrix processing, and inverse tone-mapping processing when processing path 170 applies tone-mapping processing. In some examples, a particular inverse operation may be omitted when the corresponding operation is not applied by processing path 170, when content data 160 is already represented in a state suitable for processing by processing path 170, or when a different color conditioning operation is used to prepare conditioned content data 164 for processing by image processing unit 190.

In some examples, noise conditioning 134 may be optional. In some examples, conditioning 130 may generate conditioned content data 164 without adding sensor-consistent noise, such as when content data 160 already has noise characteristics suitable for composition with raw image data 104 or when a particular application does not require noise matching. In some examples, noise conditioning 134 may be selectively enabled based on one or more of scene brightness, exposure, analog gain, digital gain, target region size, content type, user setting, power mode, and image quality setting.

Coordinates 126 and tracked coordinates 106 are shown as examples of information that can identify a target region for combining 140. Combining 140 need not receive both coordinates 126 and tracked coordinates 106 in every implementation. In some examples, combining 140 may receive fixed coordinates 126, dynamically updated tracked coordinates 106, a mask, a segmentation map, a bounding box, an object marking, a border-region designation, an output-frame boundary, content-placement metadata, application-layer instructions, or a combination thereof.

Micro-pipe 172 may be optional. In some examples, tracked coordinates 106 may be generated using micro-pipe 172. In some examples, tracked coordinates 106 or another target-region indication may be generated by processing path 170, a host processor, an application processor, a graphics processor, a neural processing unit, a programmable accelerator, fixed-function circuitry, a detector, a tracker, a segmentation module, user input, or an external application. In some examples, imaging system 100 may omit micro-pipe 172, such as when content data 160 is composited at fixed coordinates or when target-region information is generated outside image processing unit 190.

Parameters 110 and parameters 166 may be optional or may represent different instances of shared camera-state information. In some examples, conditioning 130 may use parameters 110 received from image processing unit 190, parameters 166 received from another component, internally stored parameters, calibration data, frame metadata, sensor metadata, image sensor registers, camera-controller data, three-A controller data, tuning data, or a combination thereof. In some examples, conditioning 130 may generate conditioned content data 164 without receiving one or more of parameters 110 and parameters 166.

Processing path 170 may apply any suitable set of image signal processing operations to composite raw image data 108. In some examples, processing path 170 may apply one or more of demosaicing, white balance, color correction, denoising, temporal noise reduction, spatial noise reduction, sharpening, detail processing, tone mapping, gamma correction, color-space conversion, scaling, and output formatting. Processing path 170 need not apply every listed operation in every implementation. In some examples, processing path 170 may process composite raw image data 108 before, after, or between selected image signal processing stages, provided that at least one image signal processing operation is applied after conditioned content data 164 is combined with raw image data 104.

Compositing 180 is illustrated separately from image processing unit 190, but other arrangements may be used. In some examples, one or more portions of compositing 180 may be implemented in image processing unit 190, upstream of image processing unit 190, in a camera subsystem, in a host processor, in a graphics processor, in a neural processing unit, in a programmable accelerator, in fixed-function circuitry, in firmware, in software, or in a combination thereof. Similarly, conditioning 130 and combining 140 may be implemented by a common processing circuit or by separate processing circuits.

Although FIG. 1 illustrates raw image data 104 being provided to compositing 180 and image processing unit 190, imaging system 100 may use different routing arrangements. In some examples, raw image data 104 may be provided to compositing 180, to micro-pipe 172, to processing path 170, to a raw frame buffer, or to a combination thereof. In some examples, composite raw image data 108 may be stored in a buffer before being received by image processing unit 190. In some examples, raw image data 104 and composite raw image data 108 may represent a full frame, a region of a frame, a tile, a line group, a block, or another image-data unit.

### Raw-Domain Compositing Techniques

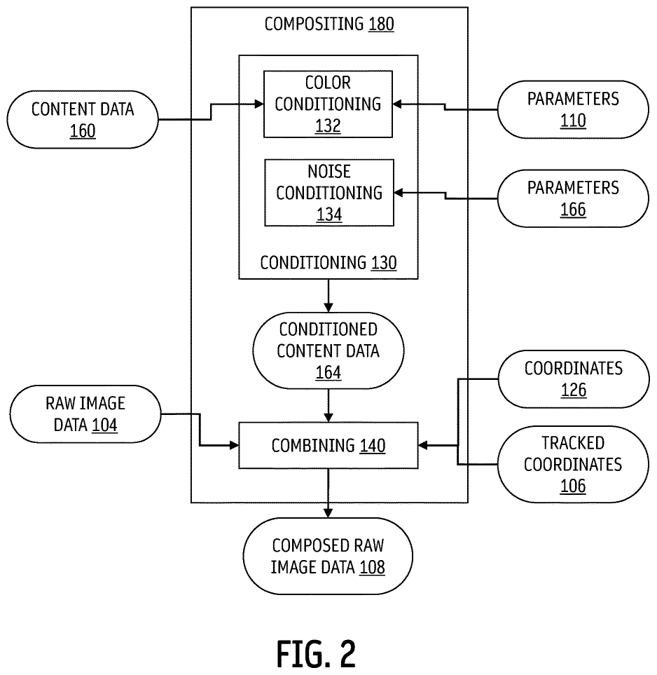

FIG. 2 illustrates implementations of compositing 180, according to some examples of the disclosure. Rounded-corner blocks in FIG. 2 represent data, and rectangular blocks in FIG. 2 represent operations, functional blocks, circuitry, software modules, firmware modules, or combinations thereof. Compositing 180 can receive content data 160 and raw image data 104 and can generate composite raw image data 108. In some examples, compositing 180 can comprise conditioning 130 and combining 140. Conditioning 130 can generate conditioned content data 164 from content data 160, and combining 140 can combine conditioned content data 164 with raw image data 104 to generate composite raw image data 108.

Content data 160 can comprise data representing content to be inserted into, substituted for, generated for, or used to extend a captured frame. In some examples, content data 160 comprises one or more of graphical object data, logo data, virtual object data, background replacement data, inpainted region data, and outpainted region data. Content data 160 may be received in a format that differs from raw image data 104. For example, content data 160 may comprise data in one or more of a processed image domain, a linear image domain, a graphics domain, a generated-content domain, a stored asset domain, and a raw sensor domain.

Raw image data 104 can comprise image data generated by an image sensor before at least one image signal processing operation is performed. In some examples, raw image data 104 can comprise mosaiced raw image data, Bayer-pattern image data, non-demosaiced image data, image data in a raw sensor domain, or image data derived from sensor output before demosaicing. Compositing 180 can operate on raw image data 104 before one or more image signal processing operations are applied to raw image data 104 so that composite raw image data 108 can be processed by an image signal processing pipeline after conditioned content data 164 has been introduced into raw image data 104.

Conditioning 130 can process, convert, modify, generate, or adjust content data 160 to generate conditioned content data 164. In some examples, conditioned content data 164 can comprise conditioned raw content data suitable for composition with raw image data 104. Conditioning 130 can comprise one or more of format conversion, mosaicing, spatial adjustment, resizing, warping, alpha generation, mask generation, boundary adjustment, color conditioning 132, and noise conditioning 134. Conditioning 130 may perform different combinations of conditioning operations for different types of content data 160. For example, conditioning 130 may condition logo data using color conditioning 132 and noise conditioning 134, may condition inpainted region data using noise conditioning 134 and raw-domain format conversion, and may condition outpainted region data using spatial adjustment, mosaicing, and noise conditioning 134.

Color conditioning 132 can modify content data 160 based on parameters 110. In some examples, parameters 110 can comprise one or more parameters associated with capture or image signal processing of a captured frame. For example, parameters 110 can comprise one or more of a white-balance parameter, a color-correction parameter, an exposure parameter, an analog gain, a digital gain, a black-level parameter, an image signal processor tuning parameter, a tone-mapping parameter, a gamma parameter, and a color-space conversion parameter. Color conditioning 132 can reflect, compensate for, or complement one or more color-related operations to be applied after combining 140. In some examples, color conditioning 132 comprises applying an inverse of at least one color-related image-processing operation, such as one or more of an inverse white-balance operation, an inverse partial-white-balance operation, an inverse color-correction-matrix operation, an inverse tone-mapping operation, an inverse gamma operation, and an inverse color-space conversion operation.

The particular operations performed by color conditioning 132 can vary based on the image signal processing pipeline that will process composite raw image data 108. For example, color conditioning 132 may apply inverse white-balance processing when a later processing path applies white-balance processing, may apply inverse color-correction-matrix processing when a later processing path applies color-correction-matrix processing, and may apply inverse tone-mapping processing when a later processing path applies tone-mapping processing. In some examples, color conditioning 132 can generate conditioned content data 164 so that, after composite raw image data 108 is processed by the image signal processing pipeline, pixels corresponding to conditioned content data 164 have a target color appearance relative to captured-image pixels.

In some examples, color conditioning 132 accounts for partial white-balance correction applied by image processing unit 190. For example, image processing unit 190 may apply partial white-balance correction to preserve a scene-dependent color impression, such as a warmer appearance under candlelight or another illumination condition. Color conditioning 132 may reflect, compensate for, or complement the partial white-balance correction so that conditioned content data 164 is processed by image processing unit 190 in a manner that corresponds to captured-image pixels. This can allow content-derived pixels to acquire a scene-consistent color temperature after downstream image signal processing.

Noise conditioning 134 can modify content data 160 based on parameters 166. In some examples, parameters 166 can comprise one or more of a sensor-noise parameter, exposure parameter, analog gain, digital gain, black-level parameter, sensor calibration parameter, intensity-dependent noise parameter, read-noise parameter, shot-noise parameter, and image signal processor tuning parameter. Noise conditioning 134 can add sensor-consistent noise to content data 160 before conditioned content data 164 is combined with raw image data 104. Sensor-consistent noise can be generated based on a physical noise model of an image sensor that captured raw image data 104. In some examples, the physical noise model comprises one or more of an intensity-dependent noise component and a read-noise component. Noise conditioning 134 can help conditioned content data 164 exhibit spatial noise characteristics and temporal noise behavior that correspond to captured-image pixels after composite raw image data 108 is processed.

In some examples, noise conditioning 134 accounts for time-varying capture conditions. For example, noise conditioning 134 may generate sensor-consistent noise based on one or more of exposure time, analog gain, digital gain, black level, and sensor-noise parameters associated with a current frame. As such parameters change across frames, noise conditioning 134 may update noise applied to content data 160 on a frame-by-frame basis. This can cause pixels corresponding to conditioned content data 164 to reflect temporal changes in capture conditions before composite raw image data 108 is processed by image processing unit 190.

Conditioning 130 may arrange color conditioning 132 and noise conditioning 134 in different orders. In some examples, color conditioning 132 may be performed before noise conditioning 134 so that noise is added after content data 160 has been converted or adjusted to a raw-domain-compatible color state. In some examples, spatial operations, such as resizing or warping, may be performed before noise conditioning 134 so that noise characteristics are not distorted by later spatial resampling. In some examples, conditioning 130 may perform a subset of illustrated operations when content data 160 is already represented in a state suitable for one or more subsequent operations. For example, a particular inverse color-related operation may be omitted when a corresponding color-related operation is not applied by a later processing path or when content data 160 already reflects that color-related state.

Combining 140 can receive conditioned content data 164 and raw image data 104 and can generate composite raw image data 108. Combining 140 can also receive coordinates 126, tracked coordinates 106, or both. Coordinates 126 and tracked coordinates 106 can represent data identifying a target region for composition. In some examples, the target region can be defined by one or more of coordinates, tracked coordinates, a bounding box, a mask, a segmentation map, an object marking, a detected object region, a tracked object region, a foreground region, a background region, and a border region of an output frame. Coordinates 126 may correspond to a static target region, and tracked coordinates 106 may correspond to a dynamically updated target region that changes across frames.

Combining 140 can combine conditioned content data 164 with raw image data 104 using different compositing operations. In some examples, combining 140 can perform one or more of pixel replacement, pixel overwriting, alpha blending, mask-based blending, segmentation-based compositing, region substitution, border-region synthesis, and frame extension. For logo insertion, combining 140 may place conditioned content data 164 at coordinates 126 or tracked coordinates 106. For background replacement, combining 140 may combine conditioned content data 164 with raw image data 104 based on a segmentation map. For content removal or inpainting, combining 140 may replace a target region associated with an object marking. For outpainting, combining 140 may combine conditioned content data 164 with raw image data 104 at a border region of an output frame.

In some examples, combining 140 may perform pixel replacement or pixel overwriting in a target region, and image processing unit 190 may subsequently apply filtering, denoising, sharpening, detail processing, demosaicing, or another image signal processing operation to composite raw image data 108. Applying downstream image signal processing after pixel replacement or pixel overwriting can reduce visual discontinuities at boundaries of the target region. In some examples, combining 140 may also use alpha blending, mask-based blending, segmentation-based blending, or boundary-region blending to further control a transition between captured-image pixels and pixels corresponding to conditioned content data 164.

Composite raw image data 108 can comprise raw image data generated by compositing conditioned content data 164 with raw image data 104. In some examples, composite raw image data 108 represents a full frame, a region of a frame, a tile, a line group, a block, or another image-data unit. Generating composite raw image data 108 before downstream image signal processing allows later image signal processing operations to process captured-image pixels and pixels corresponding to conditioned content data 164 in a common processing flow. This can improve color consistency, detail consistency, spatial noise consistency, temporal noise behavior, latency, power efficiency, and robustness to changing capture conditions.

### Content Conditioning Techniques

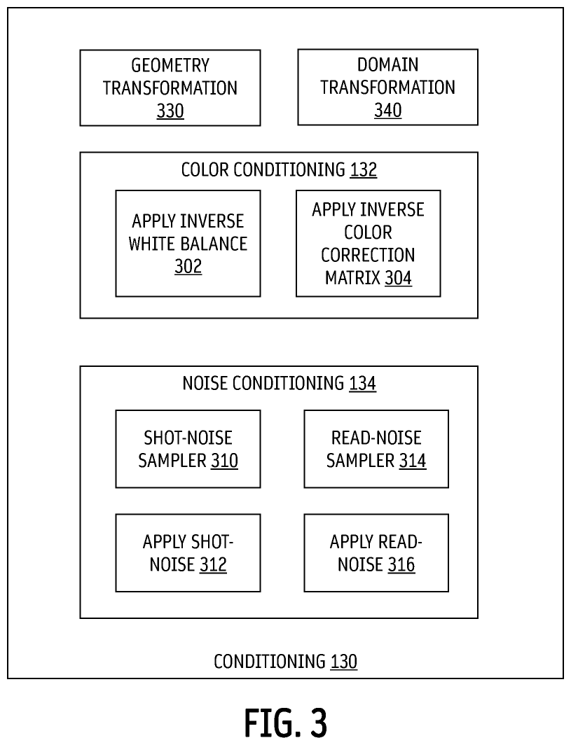

FIG. 3 illustrates implementations of conditioning 130, according to some examples of the disclosure. Conditioning 130 can be used to generate conditioned content data 164 from content data 160 before content data 160 is composited with raw image data 104. Conditioning 130 can comprise one or more of geometry transformation 330, domain transformation 340, color conditioning 132, and noise conditioning 134. In some examples, conditioning 130 can be performed in a sequence selected based on content type, target region, image sensor characteristics, and image processing operations to be applied after compositing.

Geometry transformation 330 can spatially transform content data 160 before noise conditioning 134 is applied. Geometry transformation 330 can comprise one or more of resizing, scaling, cropping, rotating, translating, perspective transforming, warping, lens-distortion adjustment, and coordinate mapping. In some examples, geometry transformation 330 adjusts content data 160 so that conditioned content data 164 corresponds to a size, orientation, shape, or position of a target region of raw image data 104. Performing geometry transformation 330 before noise conditioning 134 can reduce distortion of sensor-consistent noise that could occur if noise were added before spatial resampling.

Domain transformation 340 can transform content data 160 into a domain suitable for composition with raw image data 104. Domain transformation 340 can comprise one or more of converting processed image data into linear image data, converting RGB data into sensor color-channel data, converting content data 160 into a raw sensor domain, converting content data 160 into mosaiced raw image data, mapping content samples to a Bayer pattern, and quantizing content data 160 to a bit depth associated with raw image data 104. For example, when raw image data 104 comprises RGGB Bayer data, domain transformation 340 may sample or arrange content data 160 so that red, green, and blue content values are placed at corresponding red, green, and blue pixel locations of a Bayer pattern.

Color conditioning 132 can modify content data 160 based on one or more color-related operations to be applied by a downstream image signal processing pipeline. Color conditioning 132 can comprise one or more of applying inverse white balance 302 and applying inverse color correction matrix 304. More generally, color conditioning 132 can reflect, compensate for, or complement one or more downstream color-related operations, such as white-balance processing, partial white-balance processing, color-correction-matrix processing, color-space conversion, tone mapping, gamma correction, local color processing, and image signal processor tuning. The particular operations performed by color conditioning 132 may vary based on the implementation of the downstream processing path.

Applying inverse white balance 302 can adjust content data 160 based on white-balance gains that will be applied after compositing. For example, content data 160 may have a target color value C_{target}, which represents a desired color appearance after downstream white-balance processing. If downstream processing applies a white-balance operation represented by a diagonal gain matrix W=diag(g_{R}, g_{G}, g_{B}), applying inverse white balance 302 may generate a pre-white-balance color value C_{prewB} according to C_{prewB}=W⁻¹C_{target}, where W⁻¹=diag(1/g_{R}, 1/g_{G}, 1/g_{B}). When downstream processing subsequently applies white balance, the processed value becomes WC_{preWB}=WW⁻¹C_{target}=C_{target}. In some examples, W may represent full white-balance correction or partial white-balance correction. Applying inverse white balance 302 can prepare conditioned content data 164 so that pixels corresponding to conditioned content data 164 reach a desired color appearance after the downstream image signal processing pipeline applies white-balance processing.

Applying inverse color correction matrix 304 can adjust content data 160 based on a color correction matrix that will be applied after compositing. For example, content data 160 may have a target color value C_{target}, which represents a desired color appearance after downstream color-correction-matrix processing. If downstream processing applies a color-correction-matrix operation represented by matrix M_{CCM}, applying inverse color correction matrix 304 may generate a pre-color-correction color value C_{preCCM} according to

$${C}_{preCCM} = {M}_{CCM}^{- 1} {C}_{target} .$$

When downstream processing subsequently applies color-correction-matrix processing, the processed value becomes

$${M}_{CCM} {C}_{preCCM} = {M}_{CCM} {M}_{CCM}^{- 1} {C}_{target} = {C}_{target} .$$

In some examples, M_{CCM} may represent a full color correction matrix, a partial color correction matrix, a color conversion matrix, or a matrix associated with image signal processor tuning. Applying inverse color correction matrix 304 can prepare conditioned content data 164 so that pixels corresponding to conditioned content data 164 reach a desired color appearance after the downstream image signal processing pipeline applies color-correction-matrix processing.

In some examples, color conditioning 132 can apply inverse operations in an order that corresponds to an inverse of a downstream color-processing sequence. For example, if downstream processing applies a white-balance operation followed by a color-correction-matrix operation, the downstream color-processing sequence may be represented as Cₒᵤₜ=M_{CCM}WCₚᵣₑ, where W represents a white-balance gain matrix and M_{CCM} represents a color correction matrix. To produce target color value C_{target} after downstream processing, color conditioning 132 may generate color-conditioned content value C_{cond} according to

$${C}_{cond} = {W}^{- 1} {M}_{CCM}^{- 1} {C}_{target} .$$

When downstream processing subsequently applies the color-processing sequence, the processed value becomes

$${M}_{CCM} {WC}_{cond} = {M}_{CCM} {WW}^{- 1} {M}_{CCM}^{- 1} {C}_{target} = {C}_{target} .$$

In some examples, a different inverse sequence may be used based on the order, type, or mathematical form of color-related operations applied by the downstream image signal processing pipeline.

In some examples, color conditioning 132 applies inverse color-related operations in a reverse order relative to an order in which corresponding color-related operations are applied by downstream processing, such that a later-applied downstream color-related operation is compensated for by an earlier-applied inverse color-related operation during color conditioning 132.

Noise conditioning 134 can add sensor-consistent noise to content data 160, color-conditioned content data, domain-transformed content data, geometry-transformed content data, or a combination thereof. Noise conditioning 134 can comprise shot-noise sampler 310, apply shot-noise 312, read-noise sampler 314, and apply read-noise 316. Noise conditioning 134 can use a physical noise model of an image sensor that captured raw image data 104. In some examples, the physical noise model comprises one or more of an intensity-dependent noise component and a read-noise component. Noise conditioning 134 can use parameters such as exposure, analog gain, digital gain, black level, sensor calibration data, k-coefficients, b-coefficients, and image signal processor tuning parameters.

Shot-noise sampler 310 can generate a shot-noise component based on light intensity represented by a clean content pixel value. In some examples, shot-noise sampler 310 samples from a Poisson-based distribution. For example, for clean pixel intensity I and gain-dependent coefficient k(g), shot-noise sampler 310 may generate a shot-noise-adjusted value IS according to IS=Poisson (k(g)I)/k(g), and apply shot-noise 312 may generate a shot-noise component NS=IS−I. In some examples, an approximation may be used, such as NS~N(0,k(g)I), where variance depends on pixel intensity. This intensity-dependent noise component can cause brighter and darker portions of conditioned content data 164 to exhibit different noise levels in a manner corresponding to sensor behavior.

Read-noise sampler 314 can generate a read-noise component associated with sensor electronics. In some examples, read-noise sampler 314 samples from a Gaussian-based distribution. For example, read-noise sampler 314 may generate NR~N(0,b(g)), where b(g) is a gain-dependent read-noise coefficient. Apply read-noise 316 may add NR to a pixel value after, before, or together with the shot-noise component. A resulting noisy pixel value may be represented as IN=clip(I+NS+NR) or IN-clip(Poisson (k(g)I)/k(g)+NR), where clip represents limiting the noisy pixel value to a valid range for conditioned content data 164. In some examples, black level, saturation level, quantization, and bit depth may also be applied as part of noise conditioning 134.

Noise conditioning 134 can be generalized beyond the example equations. In some examples, shot-noise sampler 310, read-noise sampler 314, apply shot-noise 312, and apply read-noise 316 can implement one or more of a calibrated sensor-noise model, a lookup-table-based model, a per-pixel model, a per-channel model, a gain-dependent model, an exposure-dependent model, a black-level-dependent model, and a time-varying noise model. Noise samples may be generated independently per frame, generated using a seed associated with a frame, generated based on pixel location, generated based on color channel, or generated based on temporal state. Generating noise before compositing can allow pixels corresponding to conditioned content data 164 to be processed by downstream temporal noise reduction together with captured-image pixels.

In some examples, noise conditioning 134 is performed using pixel-wise operations based on a physical sensor model. For example, noise conditioning 134 may generate a noisy pixel value for each pixel or group of pixels of content data 160 based on a clean pixel value and one or more gain-dependent, exposure-dependent, black-level-dependent, or sensor-calibrated parameters. Performing such noise conditioning before downstream image signal processing can allow simple pixel-wise calculations in the raw sensor domain to account for sensor noise behavior that may be more difficult to reproduce after image processing has been applied.

Conditioning 130 can use different subsets and orders of the operations shown in FIG. 3 for different applications. For logo insertion, conditioning 130 may perform geometry transformation 330 to size a logo for a target region, domain transformation 340 to generate Bayer-pattern content, color conditioning 132 to apply inverse white balance 302 and inverse color correction matrix 304, and noise conditioning 134 to add shot and read noise before raw-domain compositing. For background replacement, conditioning 130 may condition replacement background content based on color-related parameters and sensor-noise parameters. For inpainting, conditioning 130 may generate or receive inpainted region data, transform the inpainted region data into a raw-domain-compatible form, and apply sensor-consistent noise. For outpainting, conditioning 130 may generate or receive content for a border region of an output frame and condition that content so that an expanded raw frame can be processed by a common image signal processing pipeline.

### Micro-Pipe-Based Target Region Determination

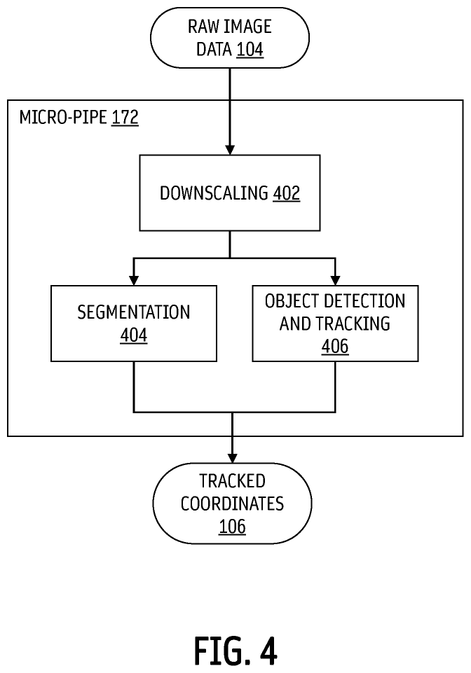

FIG. 4 illustrates implementations of micro-pipe 172, according to some examples of the disclosure. Rounded-corner blocks in FIG. 4 represent data, and rectangular blocks in FIG. 4 represent operations, functional blocks, circuitry, software modules, firmware modules, or combinations thereof. Micro-pipe 172 can receive raw image data 104 and generate tracked coordinates 106. Tracked coordinates 106 can be used by compositing 180 to determine a target region into which conditioned content data 164 is composited with raw image data 104.

Micro-pipe 172 can operate as a processing path that is different from, and in some examples parallel with, a processing path that generates processed image data 188. Micro-pipe 172 can process raw image data 104 to generate a reduced-complexity representation of a captured frame for analysis. In some examples, micro-pipe 172 generates tracked coordinates 106 without requiring full-resolution image signal processing of raw image data 104. Using micro-pipe 172 in this manner can reduce latency, memory bandwidth, and power consumption associated with determining a target region for raw-domain compositing.

Downscaling 402 can generate a reduced-resolution image from raw image data 104. In some examples, downscaling 402 can comprise one or more of spatial filtering, subsampling, binning, decimation, interpolation, demosaicing at a reduced resolution, color-space conversion, luminance extraction, and generation of a preview image or proxy image. The reduced-resolution image may comprise one or more of reduced-resolution raw image data, reduced-resolution RGB image data, reduced-resolution luminance data, reduced-resolution chrominance data, and feature data derived from raw image data 104. Downscaling 402 can make later analysis operations less computationally expensive while preserving information sufficient to determine tracked coordinates 106.

In some examples, micro-pipe 172 generates a reduced-resolution processed image from raw image data 104. The reduced-resolution processed image may comprise one or more of a reduced-resolution RGB image, a reduced-resolution luminance image, a preview image, a proxy image, and feature data derived from raw image data 104. One or more of statistics, a neural network, a detector, a tracker, a segmentation module, a motion estimation module, and a coordinate generator may operate on the reduced-resolution processed image to determine tracked coordinates 106. This can allow target-region determination to be performed with lower power and lower latency than full-resolution processing.

Segmentation 404 can analyze an output of downscaling 402 to determine region information for one or more portions of a captured frame. In some examples, segmentation 404 can generate one or more of a foreground mask, a background mask, a person mask, a face mask, a body-part mask, an object mask, a semantic segmentation map, and an instance segmentation map. Segmentation 404 can be used to determine tracked coordinates 106 corresponding to a region where conditioned content data 164 is to be inserted, a region to be preserved during background replacement, a region to be replaced during object removal, or a border between captured-image pixels and content-derived pixels.

Object detection and tracking 406 can analyze an output of downscaling 402 to determine tracked coordinates 106 for one or more objects or regions across a plurality of frames. In some examples, object detection and tracking 406 can comprise one or more of face detection, body detection, hand detection, clothing detection, surface tracking, feature tracking, optical-flow estimation, motion-vector estimation, template matching, bounding-box tracking, landmark tracking, keypoint tracking, and neural-network-based detection. Object detection and tracking 406 can determine movement of one or more of a surface, an object, a face, a body portion, and a foreground subject so that conditioned content data 164 remains aligned with a moving target region.

In some examples, tracked coordinates 106 may be generated using motion estimation between frames. For example, micro-pipe 172 may compare a reduced-resolution image generated for a current frame with a reduced-resolution image generated for a previous frame to estimate motion of one or more regions. Motion estimation may comprise one or more of block matching, template matching, correlation, sum of absolute differences, sum of squared differences, phase correlation, feature matching, sparse optical flow, and dense optical flow. Based on the estimated motion, micro-pipe 172 may update coordinates of a target region from a previous frame to generate tracked coordinates 106 for a current frame. This can allow conditioned content data 164 to follow a moving surface or object without performing full object detection for every frame.

In some examples, tracked coordinates 106 may be generated using landmarks or keypoints. For example, micro-pipe 172 may determine one or more of facial landmarks, body landmarks, hand landmarks, pose keypoints, object keypoints, and surface feature points. Tracked coordinates 106 may be determined based on positions of such landmarks or keypoints, a distance between landmarks or keypoints, an orientation defined by landmarks or keypoints, or a transformation fitted to landmarks or keypoints across frames. This can allow compositing 180 to anchor conditioned content data 164 to a face, body portion, hand, article of clothing, planar surface, or object that changes position, scale, or rotation over time.

In some examples, tracked coordinates 106 may be generated using a transformation model. For example, micro-pipe 172 may estimate one or more of a translation, scale, rotation, affine transformation, homography, perspective transformation, and deformation field associated with a target region. The transformation model may be estimated based on one or more of feature correspondences, optical flow, bounding boxes, landmarks, segmentation masks, and motion vectors. Compositing 180 may use the transformation model to warp, align, or place conditioned content data 164 in raw image data 104. This can support compositing onto non-stationary surfaces, such as clothing, walls, hands, faces, and objects that move relative to image sensor 102.

In some examples, tracked coordinates 106 may be generated using depth, disparity, or three-dimensional pose information. For example, micro-pipe 172 may receive or generate one or more of a depth map, disparity map, stereo correspondence, time-of-flight measurement, structured-light measurement, simultaneous localization and mapping output, and three-dimensional pose estimate. Tracked coordinates 106 may be determined by projecting a three-dimensional point, region, plane, or object pose into an image coordinate system associated with raw image data 104. This can allow conditioned content data 164 to be placed based on three-dimensional scene geometry while still being composited with raw image data 104 in a raw sensor domain.

In some examples, tracked coordinates 106 may be generated using application-layer information or user input. For example, an application may provide content-placement metadata, anchor metadata, object identifiers, user-selected points, a user-selected region, a crop boundary, a border-region designation, or an output-frame boundary. Micro-pipe 172 or another processing component may convert such information into tracked coordinates 106 for use by compositing 180. This can allow raw-domain compositing to support augmented-reality effects, user-selected object removal, background replacement, outpainting, aspect-ratio expansion, and static or dynamic placement specified by software outside image processing unit 190.

In some examples, tracked coordinates 106 may be generated using temporal filtering or prediction. For example, micro-pipe 172 may apply one or more of smoothing, Kalman filtering, particle filtering, exponential filtering, motion-vector prediction, optical-flow propagation, and inertial-sensor-assisted prediction to coordinates determined for one or more previous frames. Temporal filtering can reduce jitter in tracked coordinates 106, and prediction can compensate for processing latency between capture of raw image data 104 and compositing of conditioned content data 164. This can improve visual stability of conditioned content data 164 in a processed video stream.

Object detection and tracking 406 may generate intermediate coordinates in a coordinate system that differs from an image coordinate system of raw image data 104. For example, object detection and tracking 406 may generate coordinates in one or more of a reduced-resolution coordinate system, a cropped-image coordinate system, a normalized coordinate system, a neural-network input coordinate system, a display coordinate system, a processed-image coordinate system, and a three-dimensional coordinate system. Object detection and tracking 406 may transform the intermediate coordinates into image coordinates corresponding to raw image data 104. Such transformation may comprise one or more of scaling, offset correction, crop compensation, rotation compensation, lens-distortion compensation, aspect-ratio conversion, homography application, and projection from three-dimensional coordinates to two-dimensional image coordinates.

In some examples, transforming coordinates to image coordinates may account for a relationship between micro-pipe 172 and a downstream processing path. For example, downscaling 402 may generate a reduced-resolution image having a different resolution, crop, aspect ratio, or orientation than raw image data 104. Object detection and tracking 406 may determine a detected region in the reduced-resolution image, and may map the detected region back to coordinates of raw image data 104 before providing tracked coordinates 106 to compositing 180. This mapping allows combining 140 to composite conditioned content data 164 into a target region that spatially corresponds to a detected or tracked region in the captured frame.

Tracked coordinates 106 can comprise data identifying a target region for raw-domain compositing. In some examples, tracked coordinates 106 comprise one or more of coordinates, bounding-box coordinates, landmark coordinates, keypoint coordinates, polygon coordinates, mask coordinates, segmentation-map coordinates, object-center coordinates, motion vectors, affine transformation parameters, perspective transformation parameters, scale parameters, rotation parameters, and temporal tracking identifiers. Tracked coordinates 106 may identify a static region, a dynamically updated region, a region associated with an object marking, a foreground region, a background region, or a border region of an output frame.

Micro-pipe 172 can determine tracked coordinates 106 using operations in addition to, or instead of, segmentation 404 and object detection and tracking 406. In some examples, micro-pipe 172 can determine tracked coordinates 106 using one or more of motion estimation, sum of absolute differences, block matching, correlation, feature matching, sparse optical flow, dense optical flow, pose estimation, facial-landmark estimation, body-landmark estimation, depth estimation, saliency detection, edge detection, region growing, user input, application-layer metadata, and content-placement metadata. Such operations can be selected based on content type, target-region type, power mode, frame rate, accuracy requirement, and available hardware.

Micro-pipe 172 may provide different forms of tracked coordinates 106 for different applications. For logo or graphic insertion, tracked coordinates 106 may identify a position, scale, rotation, or perspective transform for placing conditioned content data 164 on a moving surface. For virtual object insertion, tracked coordinates 106 may be derived from face, body, hand, landmark, or pose information so that conditioned content data 164 remains anchored to a subject. For background replacement, tracked coordinates 106 may comprise segmentation information that distinguishes foreground pixels from background pixels. For content removal or inpainting, tracked coordinates 106 may identify an object marking or region to be replaced. For outpainting, tracked coordinates 106 may identify one or more border regions or output-frame boundaries.

In some examples, micro-pipe 172 can be implemented by one or more of a reduced-power image processing path, fixed-function circuitry, programmable image processing circuitry, a central processing unit, a graphics processing unit, a neural processing unit, a programmable accelerator, firmware, and software. In some examples, one or more operations shown inside micro-pipe 172 may be omitted, combined, reordered, or performed outside micro-pipe 172. For example, downscaling 402 may be performed by sensor readout circuitry or another image processing unit, segmentation 404 may be performed by a neural processing unit, and object detection and tracking 406 may be performed by a host processor.

Using micro-pipe 172 to generate tracked coordinates 106 can allow imaging system 100 to update target-region information across frames while composite raw image data 108 is processed by image processing unit 190. This can support real-time raw-domain video compositing in which conditioned content data 164 tracks motion in a captured scene while still being processed with captured-image pixels by a common downstream image signal processing pipeline. As a result, imaging system 100 can improve alignment accuracy, reduce computational cost, reduce power consumption, reduce latency, and support temporally consistent compositing for moving subjects or moving surfaces.

### Logo and Graphic Insertion Examples

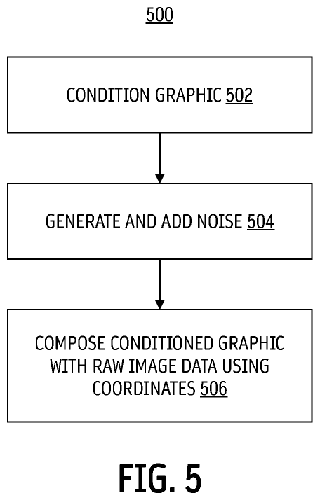

FIG. 5 is a flowchart illustrating method 500 for inserting a logo or graphic, according to some examples of the disclosure. Method 500 can be performed by imaging system 100, compositing 180, conditioning 130, combining 140, one or more processing circuits, or a combination thereof. Method 500 illustrates an example in which content data 160 comprises graphical object data, logo data, or graphic data that is conditioned before image signal processing of a captured frame and composited with raw image data 104 in a raw sensor domain.

In 502, imaging system 100 conditions a graphic. Performing conditioning of the graphic can include processing, converting, modifying, or adjusting graphical content data to generate conditioned content data 164. In some examples, performing conditioning of the graphic involves one or more of geometry transformation 330, domain transformation 340, and color conditioning 132. For example, conditioning the graphic may comprise resizing, scaling, rotating, warping, or positioning the graphic for a target region; converting the graphic from a processed image domain, graphics domain, linear image domain, or stored asset domain into a raw sensor domain; mapping the graphic to a mosaiced raw format; or applying color conditioning 132 based on one or more color-related operations to be applied by a downstream image signal processing pipeline.

In some examples, conditioning the graphic in 502 includes applying inverse color-related operations that reflect, compensate for, or complement color-related operations to be applied after compositing. For example, conditioning the graphic may include applying one or more of inverse white-balance processing and inverse color-correction-matrix processing based on one or more of a white-balance parameter, a color-correction parameter, and an image signal processor tuning parameter. Applying such color conditioning can prepare the graphic so that, after composite raw image data 108 is processed by image processing unit 190, pixels corresponding to the graphic have a desired color appearance relative to captured-image pixels of the frame.

In 504, imaging system 100 generates and adds noise. Performing generation and addition of noise can include generating sensor-consistent noise based on one or more parameters associated with image sensor 102, capture of the frame, or image signal processing of the frame. In some examples, performing generation and addition of noise involves generating noise based on one or more of a physical noise model, a sensor-noise parameter, an exposure parameter, an analog gain, a digital gain, a black-level parameter, sensor calibration data, an intensity-dependent noise component, and a read-noise component. The noise may comprise one or more of shot noise and read noise, and may be generated on a per-pixel, per-channel, per-frame, or time-varying basis.

In some examples, generating and adding noise in 504 is performed after geometry transformation of the graphic. For example, the graphic may first be resized, warped, or mapped to a target region, and sensor-consistent noise may then be added to the resized, warped, or mapped graphic. Adding noise after spatial transformation can avoid resampling the added noise and can help the noise characteristics of conditioned content data 164 correspond to noise characteristics of raw image data 104. Adding sensor-consistent noise before downstream image signal processing also allows pixels corresponding to the graphic to be processed by temporal noise reduction together with captured-image pixels.

In 506, imaging system 100 composes the conditioned graphic with raw image data using coordinates. Performing composition of the conditioned graphic with raw image data can include combining conditioned content data 164 with raw image data 104 to generate composite raw image data 108. In some examples, performing composition involves determining a target region of raw image data 104 using coordinates 126, tracked coordinates 106, a bounding box, a mask, a segmentation map, a placement rule, content-placement metadata, or a combination thereof. Coordinates 126 may define a static location for the graphic, and tracked coordinates 106 may define a location that changes across frames to cause the graphic to follow a moving object, surface, face, body portion, or foreground subject.

In some examples, composing the conditioned graphic with raw image data in 506 includes overwriting pixels of raw image data 104, replacing pixels of raw image data 104, alpha blending conditioned content data 164 with raw image data 104, or mask blending conditioned content data 164 with raw image data 104. Composing the conditioned graphic before downstream image signal processing can cause the graphic and captured-image pixels to be processed by a common image signal processing pipeline. This can improve color consistency, detail consistency, spatial noise consistency, temporal noise behavior, and robustness to changing capture conditions while supporting real-time insertion of a logo or graphic into video.

### Content Removal and Inpainting Examples

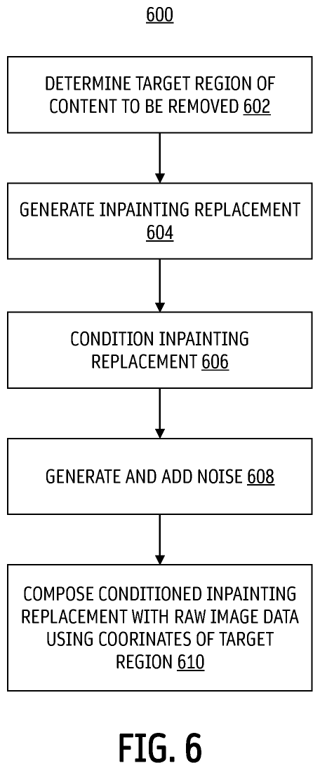

FIG. 6 is a flowchart illustrating method 600 for content removal and inpainting, according to some examples of the disclosure. Method 600 can be performed by imaging system 100, compositing 180, conditioning 130, combining 140, one or more processing circuits, or a combination thereof. Method 600 illustrates an example in which content data 160 comprises inpainted region data generated to replace, reconstruct, remove, or synthesize a target region of raw image data 104 before composite raw image data 108 is processed by image processing unit 190.

In 602, imaging system 100 determines a target region of content to be removed. Performing determination of the target region can include identifying a portion of a captured frame corresponding to content to be removed, replaced, reconstructed, or synthesized. In some examples, performing determination of the target region involves using one or more of coordinates, a bounding box, a mask, a segmentation map, an object marking, tracked coordinates 106, user input, application-layer metadata, and output of micro-pipe 172. The target region may correspond to an object in a background, an undesired object, a region marked by a user, a region detected by an image analysis process, or a region selected for reconstruction.

In 604, imaging system 100 generates an inpainting replacement. Performing generation of the inpainting replacement can include generating content data 160 that represents replacement content for the target region determined in 602. In some examples, performing generation of the inpainting replacement involves generating inpainted region data based on one or more of surrounding image data, a mask, an object marking, a segmentation map, a classical image-processing algorithm, a patch-based synthesis process, interpolation, extrapolation, a neural network, a generative model, and a diffusion model. The inpainting replacement may be generated from image information surrounding the target region so that the replacement content is visually consistent with nearby captured content.

In some examples, method 600 preserves foreground content while replacing or reconstructing a target region. For example, when a foreground subject occludes a region associated with an inpainting replacement, imaging system 100 may use a segmentation map, foreground mask, person mask, depth map, or object mask to preserve pixels corresponding to the foreground subject while compositing conditioned inpainting replacement data into a background or target region. This can allow the inpainting replacement to affect pixels corresponding to content to be removed while maintaining captured foreground pixels in composite raw image data 108.

In 606, imaging system 100 conditions the inpainting replacement. Performing conditioning of the inpainting replacement can include processing, converting, modifying, or adjusting the inpainting replacement to generate conditioned content data 164. In some examples, performing conditioning of the inpainting replacement involves one or more of geometry transformation 330, domain transformation 340, color conditioning 132, and format conversion to a raw sensor domain. For example, conditioning the inpainting replacement may comprise mapping the inpainting replacement to a mosaiced raw format, aligning the inpainting replacement with a Bayer pattern of raw image data 104, adjusting the replacement based on capture or image signal processing parameters, or preparing the replacement for subsequent processing by image processing unit 190.

In some examples, conditioning the inpainting replacement in 606 may differ from conditioning a stored logo or graphic. For example, when the inpainting replacement is generated based on surrounding image data from the captured frame, the inpainting replacement may already reflect at least some color characteristics of the scene. In such examples, conditioning the inpainting replacement may emphasize domain transformation 340, geometry transformation 330, sensor-consistent noise, gain-based adjustment, exposure-based adjustment, black-level adjustment, or alignment with the target region. In other examples, color conditioning 132 may reflect, compensate for, or complement one or more color-related operations to be applied by downstream processing.

In 608, imaging system 100 generates and adds noise. Performing generation and addition of noise can include generating sensor-consistent noise for the conditioned inpainting replacement before the conditioned inpainting replacement is composited with raw image data 104. In some examples, performing generation and addition of noise involves generating noise based on one or more of a physical noise model of image sensor 102, an intensity-dependent noise component, a read-noise component, a shot-noise component, exposure, analog gain, digital gain, black level, sensor calibration data, and sensor-noise parameters. Adding sensor-consistent noise can help the inpainting replacement avoid appearing as an unnaturally clean or static region after image processing.

In 610, imaging system 100 composes the conditioned inpainting replacement with raw image data using coordinates of the target region. Performing composition of the conditioned inpainting replacement with raw image data can include combining conditioned content data 164 with raw image data 104 to generate composite raw image data 108. In some examples, performing composition involves replacing, overwriting, alpha blending, mask blending, or segmentation-based compositing of conditioned content data 164 into the target region determined in 602. Coordinates of the target region may comprise one or more of coordinates 126, tracked coordinates 106, a mask boundary, a segmentation-map region, an object marking, a bounding box, and pixel locations corresponding to content to be removed.

In some examples, composing the conditioned inpainting replacement with raw image data in 610 is performed before downstream image signal processing. Processing composite raw image data 108 after composition can cause captured-image pixels and pixels corresponding to the conditioned inpainting replacement to pass through a common image signal processing pipeline. For example, image processing unit 190 may apply one or more of demosaicing, white balance, color correction, tone mapping, spatial noise reduction, temporal noise reduction, sharpening, detail processing, and output formatting to composite raw image data 108. Applying such processing after composition can improve color consistency, detail consistency, spatial noise consistency, and temporal noise behavior between the inpainted target region and adjacent captured-image regions.

### Outpainting and Frame Expansion Examples

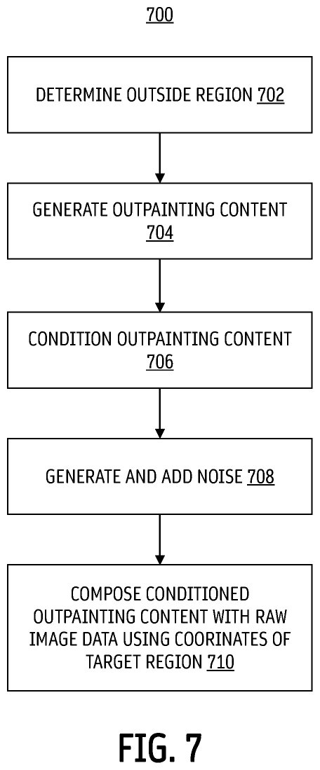

FIG. 7 is a flowchart illustrating method 700 for outpainting, according to some examples of the disclosure. Method 700 can be performed by imaging system 100, compositing 180, conditioning 130, combining 140, one or more processing circuits, or a combination thereof. Method 700 illustrates an example in which content data 160 comprises outpainted region data generated to extend a captured frame, expand an output frame boundary, or synthesize content for a region outside a selected portion of raw image data 104 before composite raw image data 108 is processed by image processing unit 190.

In 702, imaging system 100 determines an outside region. Performing determination of the outside region can include identifying a region for which outpainting content is to be generated. In some examples, performing determination of the outside region involves determining one or more of an output-frame boundary, a target aspect ratio, a target field of view, a crop boundary, a border region, a region adjacent to raw image data 104, a region outside a selected region of raw image data 104, and coordinates of a target region for frame expansion. For example, the outside region may comprise one or more of a left border region, a right border region, a top border region, and a bottom border region used to generate an output frame having a desired aspect ratio.

In 704, imaging system 100 generates outpainting content. Performing generation of the outpainting content can include generating content data 160 that represents synthesized content for the outside region determined in 702. In some examples, performing generation of the outpainting content involves generating outpainted region data based on one or more of edge pixels of raw image data 104, image data adjacent to the outside region, scene context, a mask, an output-frame boundary, a classical image-processing algorithm, interpolation, extrapolation, patch-based synthesis, a neural network, a generative model, and a diffusion model. The outpainting content may be generated to extend scene structure, color, texture, or background content from a captured frame into the outside region.

In 706, imaging system 100 conditions the outpainting content. Performing conditioning of the outpainting content can include processing, converting, modifying, or adjusting the outpainting content to generate conditioned content data 164. In some examples, performing conditioning of the outpainting content involves one or more of geometry transformation 330, domain transformation 340, color conditioning 132, and format conversion to a raw sensor domain. For example, conditioning the outpainting content may comprise aligning the outpainting content with the outside region, mapping the outpainting content to a mosaiced raw format, adjusting the outpainting content based on capture or image signal processing parameters, or preparing the outpainting content for subsequent processing by image processing unit 190.

In some examples, conditioning the outpainting content in 706 may be based on the relationship between raw image data 104 and the outside region. For example, conditioning the outpainting content may involve generating Bayer-pattern samples for pixel locations of an expanded raw frame, matching bit depth or black level of raw image data 104, adjusting content values based on one or more of exposure, analog gain, digital gain, white-balance parameters, color-correction parameters, and image signal processor tuning parameters, or aligning synthesized texture with an edge of raw image data 104. Conditioning the outpainting content can help the outside region appear as part of the same captured scene after downstream image signal processing.

In 708, imaging system 100 generates and adds noise. Performing generation and addition of noise can include generating sensor-consistent noise for the conditioned outpainting content before the conditioned outpainting content is composited with raw image data 104. In some examples, performing generation and addition of noise involves generating noise based on one or more of a physical noise model of image sensor 102, an intensity-dependent noise component, a read-noise component, a shot-noise component, exposure, analog gain, digital gain, black level, sensor calibration data, and sensor-noise parameters. Adding sensor-consistent noise can help the outpainted outside region avoid appearing as an unnaturally clean or temporally detached border region after image processing.

In 710, imaging system 100 composes the conditioned outpainting content with raw image data using coordinates of the target region. Performing composition of the conditioned outpainting content with raw image data can include combining conditioned content data 164 with raw image data 104 to generate composite raw image data 108. In some examples, performing composition involves placing, replacing, blending, stitching, or mask blending conditioned content data 164 into the outside region determined in 702. Coordinates of the target region may comprise one or more of coordinates 126, tracked coordinates 106, border-region coordinates, output-frame coordinates, crop-boundary coordinates, pixel locations of an expanded raw frame, and coordinates corresponding to a target aspect ratio.

In some examples, composing the conditioned outpainting content with raw image data in 710 generates composite raw image data 108 having a frame boundary, aspect ratio, or field of view different from a selected region of raw image data 104. For example, raw image data 104 may correspond to a native sensor aspect ratio, and composite raw image data 108 may comprise one or more synthesized border regions that allow image processing unit 190 to generate processed image data 188 having a target aspect ratio. Processing composite raw image data 108 after raw-domain composition can cause captured-image pixels and pixels corresponding to the outpainting content to pass through a common image signal processing pipeline, improving color consistency, detail consistency, spatial noise consistency, temporal noise behavior, and robustness to changing capture conditions across the expanded frame.

### Image Processing Using Conditioned Raw Content Data

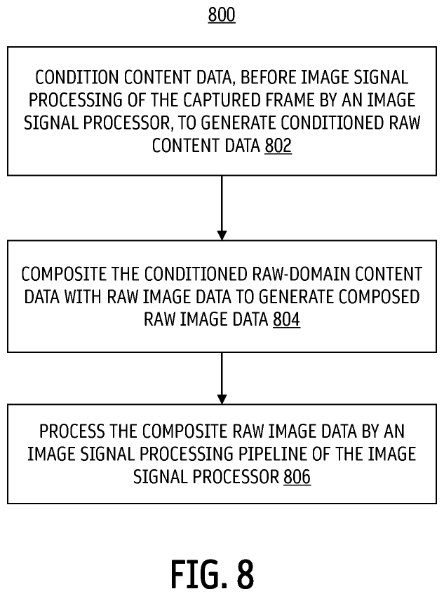

FIG. 8 is a flowchart illustrating method 800 for image processing, according to some examples of the disclosure. Method 800 can be performed by imaging system 100, compositing 180, conditioning 130, combining 140, image processing unit 190, one or more processing circuits, one or more processors executing instructions stored by one or more non-transitory computer-readable media, or a combination thereof. Method 800 illustrates a generalized process for conditioning content data before image signal processing, compositing conditioned raw content data with raw image data, and processing resulting composite raw image data using an image signal processing pipeline.

In 802, imaging system 100 conditions content data, before image signal processing of a captured frame by an image signal processor, to generate conditioned raw content data. Performing conditioning of the content data can include processing, converting, modifying, generating, or adjusting content data 160 so that the content data is suitable for composition with raw image data 104. In some examples, content data 160 comprises one or more of graphical object data, logo data, virtual object data, background replacement data, inpainted region data, and outpainted region data.

In some examples, performing conditioning in 802 involves modifying content data 160 based on one or more parameters associated with capture or image signal processing of the captured frame. The one or more parameters may comprise one or more of a white-balance parameter, a color-correction parameter, an exposure parameter, an analog gain, a digital gain, a black-level parameter, a sensor-noise parameter, and an image signal processor tuning parameter. Using such parameters can allow conditioned raw content data to reflect a current capture state, sensor state, or image-processing state of the captured frame, which can improve consistency between content-derived pixels and captured-image pixels after downstream processing.

In some examples, performing conditioning in 802 involves applying, to content data 160, an inverse of at least one image-processing operation to be applied by the image signal processing pipeline. The inverse of the at least one image-processing operation may comprise one or more of an inverse white-balance operation and an inverse color-correction-matrix operation. In some examples, inverse operations may reflect, compensate for, or complement corresponding image-processing operations to be applied later by image processing unit 190, so that pixels corresponding to conditioned raw content data have a desired appearance after processing by the image signal processing pipeline.

In some examples, performing conditioning in 802 involves adding sensor-consistent noise to content data 160 before compositing the conditioned raw content data with raw image data 104. The sensor-consistent noise may be generated based on a physical noise model of image sensor 102 that captured the frame, and the physical noise model may comprise one or more of an intensity-dependent noise component and a read-noise component. In some examples, the sensor-consistent noise is based on one or more of exposure, analog gain, digital gain, black level, sensor calibration data, and sensor-noise parameters. Adding sensor-consistent noise before image signal processing can help content-derived pixels exhibit spatial and temporal noise behavior corresponding to captured-image pixels.

In 804, imaging system 100 composites the conditioned raw-domain content data with raw image data to generate composite raw image data. Performing compositing can include combining conditioned content data 164 with raw image data 104 using combining 140. In some examples, raw image data 104 comprises mosaiced raw image data, and compositing is performed before demosaicing of the captured frame. Pre-demosaic compositing can allow the conditioned raw content data and captured-image pixels to be introduced into a common raw-domain frame before downstream image signal processing operations are applied.

In some examples, performing compositing in 804 involves compositing the conditioned raw content data into a target region defined by one or more of coordinates, a bounding box, a mask, a segmentation map, an object marking, and a border region of an output frame. The target region may correspond to a static location, a dynamically tracked location, a region to receive a graphic, a background region, a region to be inpainted, a region to be outpainted, or a region associated with an output-frame boundary. Compositing may comprise one or more of replacing pixels, overwriting pixels, blending pixels, alpha blending, mask-based blending, segmentation-based compositing, region substitution, and border-region synthesis.

In some examples, method 800 comprises determining the target region based on a reduced-resolution image generated from raw image data 104 by a processing path that operates in parallel with the image signal processing pipeline. The processing path may comprise micro-pipe 172. Determining the target region may comprise tracking, using the reduced-resolution image, one or more of motion of a surface, an object, a face, a body portion, and a foreground subject across a plurality of frames. Using a reduced-resolution image for target-region determination can reduce processing cost, memory bandwidth, latency, and power consumption while supporting dynamic placement of conditioned raw content data.

In 806, imaging system 100 processes the composite raw image data by an image signal processing pipeline of the image signal processor. Performing processing can include providing composite raw image data 108 to image processing unit 190 and applying one or more image signal processing operations to composite raw image data 108 to generate processed image data 188. In some examples, the image signal processing pipeline applies one or more of demosaicing, white balance, color correction, denoising, temporal noise reduction, spatial noise reduction, sharpening, detail processing, tone mapping, gamma correction, color-space conversion, scaling, and output formatting.

In some examples, processing composite raw image data in 806 comprises applying temporal noise reduction to both captured-image pixels of the composite raw image data and pixels corresponding to the conditioned raw content data. Because content-derived pixels are included in the composite raw image data before downstream processing, the image signal processing pipeline can process captured-image pixels and content-derived pixels using common color, detail, noise, and temporal processing. Method 800 can be implemented using one or more of a central processing unit, a graphics processing unit, a programmable accelerator, a neural processing unit, and fixed-function circuitry, which can support real-time raw-domain compositing with improved color consistency, detail consistency, spatial noise consistency, temporal noise behavior, latency, power efficiency, and robustness to changing capture conditions.

In some examples, imaging system 100 may evaluate, characterize, or control raw-domain compositing based on one or more observable properties of processed image data 188. For example, spatial noise characteristics of pixels corresponding to conditioned content data 164 may be compared with spatial noise characteristics of adjacent captured-image pixels, temporal noise characteristics of pixels corresponding to conditioned content data 164 may be compared with temporal noise characteristics of captured-image pixels across frames, and power consumption may be evaluated with raw-domain compositing enabled or disabled. Such properties can indicate that content-derived pixels and captured-image pixels are processed by a common image signal processing pipeline, including common temporal noise reduction.

### Example Computing Device

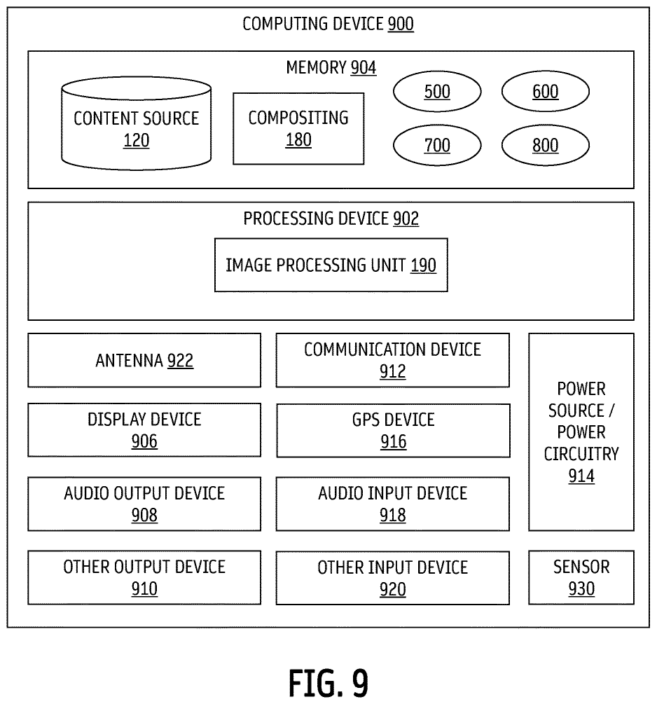

FIG. 9 is a block diagram of an apparatus or a system, e.g., an example computing device 900, according to some examples of the disclosure. One or more computing devices 900 may be used to implement the functionalities described with the FIGS. and herein. A number of components illustrated in FIG. 9 can be included in the computing device 900, but any one or more of these components may be omitted or duplicated, as suitable for the application. In some examples, some or all of the components included in the computing device 900 may be attached to one or more motherboards. In some examples, some or all of these components are fabricated onto a single system on a chip (SoC) die. Additionally, in various examples, the computing device 900 may not include one or more of the components illustrated in FIG. 9, and the computing device 900 may include interface circuitry for coupling to the one or more components. For example, the computing device 900 may not include a display device 906, and may include display device interface circuitry (e.g., a connector and driver circuitry) to which a display device 906 may be coupled. In another set of examples, the computing device 900 may not include an audio input device 918 or an audio output device 908 and may include audio input or output device interface circuitry (e.g., connectors and supporting circuitry) to which audio input device 918 or audio output device 908 may be coupled.

Computing device 900 may include processing device 902 (e.g., one or more processing devices, one or more of the same type of processing device, one or more of different types of processing devices). Processing device 902 may include electronic circuitry that processes electronic data from data storage elements (e.g., registers, memory, resistors, capacitors, quantum bit cells) to transform that electronic data into other electronic data that may be stored in registers and/or memory. Examples of processing device 902 may include a central processing unit (CPU), a graphics processing unit (GPU), an image processing unit, an image signal processor, a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a neural network hardware accelerator, a deep neural network hardware accelerator, etc.

In some examples, processing device 902 can include or be image processing unit 190, as described with reference to FIG. 1. Processing device 902 may implement one or more hardware, logic, firmware, or software components corresponding to image processing unit 190. In some examples, image processing unit 190 is a dedicated image signal processor, image processing unit, application-specific integrated circuit, or system-on-chip component to execute image processing operations. In other examples, image processing unit 190 may be implemented as one or more functional or logic blocks executed on processing device 902. Accordingly, references to operations performed by image processing unit 190 may correspond to operations performed by processing device 902, whether implemented as dedicated hardware, programmable logic, firmware, or instructions executed by processing device 902. In some examples, image processing unit 190 can be implemented as a standalone integrated circuit to perform one or more functions described herein. In some examples, image processing unit 190 can be integrated as a functional or circuit block within an SoC and as part of processing device 902, sharing resources such as memory, interconnect, and control logic with other processing components.

In some examples, memory 904 includes one or more non-transitory computer-readable media storing instructions executable to perform operations described with the FIGS. and herein. Memory 904 may include one or more non-transitory computer-readable media storing instructions executable to perform one or more operations of compositing 180, conditioning 130, color conditioning 132, noise conditioning 134, combining 140, processing path 170, micro-pipe 172, image processing unit 190, geometry transformation 330, domain transformation 340, apply inverse white balance 302, apply inverse color correction matrix 304, shot-noise sampler 310, apply shot-noise 312, read-noise sampler 314, apply read-noise 316, downscaling 402, segmentation 404, object detection and tracking 406, method 500, method 600, method 700, and method 800. The instructions stored in the one or more non-transitory computer-readable media may be executed by processing device 902.

In some examples, memory 904 may store data, data structures, binary data, bits, metadata, files, blobs, or a combination thereof, as described with the FIGS. and herein. Memory 904 may store inputs, intermediate inputs, intermediate outputs, and outputs of method 500 of FIG. 5, method 600 of FIG. 6, method 700 of FIG. 7, and method 800 of FIG. 8. Memory 904 may store content source 120, raw image data 104, tracked coordinates 106, composite raw image data 108, parameters 110, content data 160, conditioned content data 164, parameters 166, processed image data 188, and one or more raw images or processed images of imaging system 100 described and illustrated in FIG. 1.

In some examples, computing device 900 may include communication device 912 (e.g., one or more communication devices). For example, communication device 912 may be configured for managing wired and/or wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some examples they might not. Communication device 912 may implement any of a number of wireless standards or protocols. Computing device 900 may include antenna 922 to facilitate wireless communications and/or to receive other wireless communications (such as radio frequency transmissions). Computing device 900 may include receiver circuits and/or transmitter circuits. In some examples, communication device 912 may manage wired communications, such as electrical, optical, or any other suitable communication protocols (e.g., the Ethernet). As noted above, communication device 912 may include multiple communication chips. For instance, a first communication device 912 may be dedicated to shorter-range wireless communications. In some examples, a first communication device 912 may be dedicated to wireless communications, and a second communication device 912 may be dedicated to wired communications.

Computing device 900 may include power source/power circuitry 914. The power source/power circuitry 914 may include one or more energy storage devices (e.g., batteries or capacitors) and/or circuitry for coupling components of the computing device 900 to an energy source separate from the computing device 900 (e.g., DC power, AC power, etc.).

Computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

Computing device 900 may include audio output device 908 (or corresponding interface circuitry, as discussed above). Audio output device 908 may include any device that generates an audible indicator, such as speakers, headsets, or earbuds, for example.

Computing device 900 may include audio input device 918 (or corresponding interface circuitry, as discussed above). Audio input device 918 may include any device that generates a signal representative of a sound, such as microphones, microphone arrays, or digital instruments (e.g., instruments having a musical instrument digital interface (MIDI) output).

Computing device 900 may include GPS device 916 (or corresponding interface circuitry, as discussed above). GPS device 916 may be in communication with a satellite-based system and may receive a location of the computing device 900, as known in the art.

Computing device 900 may include sensor 930 (or one or more sensors). Computing device 900 may include corresponding interface circuitry, as discussed above. Sensor 930 may sense physical phenomenon and translate the physical phenomenon into electrical signals that can be processed by, e.g., processing device 902. Examples of sensor 930 may include: image sensor, capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 900 may include another output device 910 (or corresponding interface circuitry, as discussed above). Examples of the other output device 910 may include an audio codec, a video codec, a printer, a wired or wireless transmitter for providing information to other devices, haptic output device, gas output device, vibrational output device, lighting output device, home automation controller, or an additional storage device.

Computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 900 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or networked computing component, a printer, a scanner, a monitor, a set-top box, an entertainment control unit, a vehicle control unit, a digital camera, a digital video recorder, an Internet-of-Things device, or a wearable computer system. In some examples, the computing device 900 may be any other electronic device that processes data.

### SELECT EXAMPLES

Example 1 provides a processor-implemented method, including conditioning raw content data, before image signal processing by an image signal processor, to generate conditioned raw content data; compositing the conditioned raw content data with raw image data to generate composite raw image data; and processing the composite raw image data by an image signal processing pipeline of the image signal processor.

Example 2 provides the processor-implemented method of example 1, where: the raw image data includes mosaiced raw image data; and compositing the conditioned raw content data with the raw image data is performed before demosaicing in the image signal processing pipeline.

Example 3 provides the processor-implemented method of example 1 or 2, where: conditioning the raw content data includes modifying the raw content data based on one or more parameters associated with one or more of capture of the raw image data and the image signal processing pipeline.

Example 4 provides the processor-implemented method of example 3, where: the one or more parameters include one or more of: a white-balance parameter, a color-correction parameter, an exposure parameter, an analog gain, a digital gain, a black-level parameter, a sensor-noise parameter, and an image signal processor tuning parameter.

Example 5 provides the processor-implemented method of any one of examples 1-4, where: conditioning the raw content data includes applying, to the raw content data, an inverse of at least one image-processing operation to be applied by the image signal processing pipeline.

Example 6 provides the processor-implemented method of example 5, where the inverse of the at least one image-processing operation includes one or more of an inverse white-balance operation and an inverse color-correction-matrix operation.

Example 7 provides the processor-implemented method of any one of examples 1-6, where: conditioning the raw content data includes adding sensor-consistent noise to the raw content data before compositing the conditioned raw content data with the raw image data.

Example 8 provides the processor-implemented method of example 7, where: the sensor-consistent noise is generated based on a physical noise model of an image sensor that captured the raw image data, the physical noise model including one or more of an intensity-dependent noise component and a read-noise component.

Example 9 provides the processor-implemented method of any one of examples 1-8, where: the raw content data includes one or more of graphical object data, logo data, virtual object data, background replacement data, inpainted region data, and outpainted region data.

Example 10 provides the processor-implemented method of any one of examples 1-9, where: compositing the conditioned raw content data with the raw image data includes compositing the conditioned raw content data into a target region defined by one or more of coordinates, a bounding box, a mask, a segmentation map, an object marking, and a border region of an output frame.

Example 11 provides the processor-implemented method of example 10, further including determining the target region based on a reduced-resolution image generated from the raw image data by a processing path that operates in parallel with the image signal processing pipeline.

Example 12 provides the processor-implemented method of example 11, where: the processing path includes a micro-pipe; and determining the target region includes tracking, using the reduced-resolution image, one or more of motion of a surface, an object, a face, a body portion, and a foreground subject across a plurality of frames.

Example 13 provides the processor-implemented method of any one of examples 1-12, where: processing the composite raw image data by the image signal processing pipeline includes applying temporal noise reduction to both captured-image pixels of the composite raw image data and pixels corresponding to the conditioned raw content data.

Example 14 provides the processor-implemented method of any one of examples 1-13, where: conditioning the raw content data and compositing the conditioned raw content data with the raw image data are performed by one or more of a central processing unit, a graphics processing unit, a programmable accelerator, a neural processing unit, and fixed-function circuitry.

Example 15 provides one or more non-transitory computer-readable media storing instructions that, when executed by one or more processors, cause the one or more processors to perform operations including conditioning raw content data, before image signal processing by an image signal processor, to generate conditioned raw content data; compositing the conditioned raw content data with raw image data to generate composite raw image data; and outputting the composite raw image data to the image signal processor for processing by an image signal processing pipeline of the image signal processor.

Example 16 provides the one or more non-transitory computer-readable media of example 15, where: the raw image data includes mosaiced raw image data; and compositing the conditioned raw content data with the raw image data is performed before demosaicing in the image signal processing pipeline.

Example 17 provides the one or more non-transitory computer-readable media of example 15 or 16, where: conditioning the raw content data includes modifying the raw content data based on one or more parameters associated with one or more of capture of the raw image data and the image signal processing pipeline.

Example 18 provides the one or more non-transitory computer-readable media of example 17, where: the one or more parameters include one or more of: a white-balance parameter, a color-correction parameter, an exposure parameter, an analog gain, a digital gain, a black-level parameter, a sensor-noise parameter, and an image signal processor tuning parameter.

Example 19 provides the one or more non-transitory computer-readable media of any one of examples 15-18, where: conditioning the raw content data includes applying, to the raw content data, an inverse of at least one image-processing operation to be applied by the image signal processing pipeline.

Example 20 provides the one or more non-transitory computer-readable media of example 19, where: the inverse of the at least one image-processing operation includes one or more of an inverse white-balance operation and an inverse color-correction-matrix operation.

Example 21 provides the one or more non-transitory computer-readable media of any one of examples 15-20, where: conditioning the raw content data includes adding sensor-consistent noise to the raw content data before compositing the conditioned raw content data with the raw image data.

Example 22 provides the one or more non-transitory computer-readable media of example 21, where: the sensor-consistent noise is generated based on a physical noise model of an image sensor, the physical noise model including one or more of an intensity-dependent noise component and a read-noise component.

Example 23 provides the one or more non-transitory computer-readable media of any one of examples 15-22, where: the raw content data includes one or more of graphical object data, logo data, virtual object data, background replacement data, inpainted region data, and outpainted region data.

Example 24 provides the one or more non-transitory computer-readable media of any one of examples 15-23, where: compositing the conditioned raw content data with the raw image data includes compositing the conditioned raw content data into a target region defined by one or more of coordinates, a bounding box, a mask, a segmentation map, an object marking, and a border region of an output frame.

Example 25 provides the one or more non-transitory computer-readable media of example 24, where the operations further include determining the target region based on a reduced-resolution image generated from the raw image data by a processing path that operates in parallel with the image signal processing pipeline.

Example 26 provides the one or more non-transitory computer-readable media of example 25, where: the processing path includes a micro-pipe; and determining the target region includes tracking, using the reduced-resolution image, one or more of motion of a surface, an object, a face, a body portion, and a foreground subject across a plurality of frames.

Example 27 provides the one or more non-transitory computer-readable media of any one of examples 15-26, where: the image signal processing pipeline applies temporal noise reduction to both captured-image pixels of the composite raw image data and pixels corresponding to the conditioned raw content data.

Example 28 provides the one or more non-transitory computer-readable media of any one of examples 15-27, where: conditioning the raw content data and compositing the conditioned raw content data with the raw image data are performed by one or more of a central processing unit, a graphics processing unit, a programmable accelerator, a neural processing unit, and fixed-function circuitry.

Example 29 provides an image processing system, including one or more processing circuits to: condition raw content data, before image signal processing by an image signal processor, to generate conditioned raw content data; and composite the conditioned raw content data with raw image data to generate composite raw image data; and an image signal processor to: receive, from the one or more processing circuits, the composite raw image data; and process the composite raw image data using an image signal processing pipeline of the image signal processor.

Example 30 provides the image processing system of example 29, where: the raw image data includes mosaiced raw image data; and the one or more processing circuits are to composite the conditioned raw content data with the raw image data before demosaicing by the image signal processor.

Example 31 provides the image processing system of example 29 or 30, where: the one or more processing circuits are to condition the raw content data based on one or more parameters associated with one or more of capture of the raw image data and the image signal processing pipeline.

Example 32 provides the image processing system of example 31, where: the one or more parameters include one or more of: a white-balance parameter, a color-correction parameter, an exposure parameter, an analog gain, a digital gain, a black-level parameter, a sensor-noise parameter, and an image signal processor tuning parameter.

Example 33 provides the image processing system of any one of examples 29-32, where: the one or more processing circuits are to condition the raw content data by applying, to the raw content data, an inverse of at least one image-processing operation to be applied by the image signal processing pipeline.

Example 34 provides the image processing system of example 33, where: the inverse of the at least one image-processing operation includes one or more of an inverse white-balance operation and an inverse color-correction-matrix operation.

Example 35 provides the image processing system of any one of examples 29-34, where: the one or more processing circuits are to condition the raw content data by adding sensor-consistent noise to the raw content data before compositing the conditioned raw content data with the raw image data.

Example 36 provides the image processing system of example 35, where: the sensor-consistent noise is generated based on a physical noise model of an image sensor that captured the raw image data, the physical noise model including one or more of an intensity-dependent noise component and a read-noise component.

Example 37 provides the image processing system of any one of examples 29-36, where: the raw content data includes one or more of graphical object data, logo data, virtual object data, background replacement data, inpainted region data, and outpainted region data.

Example 38 provides the image processing system of any one of examples 29-37, where: the one or more processing circuits are to composite the conditioned raw content data into a target region of the raw image data, the target region being defined by one or more of coordinates, a bounding box, a mask, a segmentation map, an object marking, and a border region of an output frame.

Example 39 provides the image processing system of example 38, further including a processing path to generate a reduced-resolution image from the raw image data in parallel with the image signal processing pipeline, where the one or more processing circuits are to determine the target region based on the reduced-resolution image.

Example 40 provides the image processing system of example 39, where: the processing path includes a micro-pipe; and the one or more processing circuits are to determine the target region by tracking, using the reduced-resolution image, one or more of motion of a surface, an object, a face, a body portion, and a foreground subject across a plurality of frames.

Example 41 provides the image processing system of any one of examples 29-40, where: the image signal processing pipeline is to apply temporal noise reduction to both captured-image pixels of the composite raw image data and pixels corresponding to the conditioned raw content data.

Example 42 provides the image processing system of any one of examples 29-41, where: the one or more processing circuits include one or more of a central processing unit, a graphics processing unit, a programmable accelerator, a neural processing unit, and fixed-function circuitry.

### VARIATIONS AND REMARKS

Although the operations of the example method shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A processor-implemented method, comprising:
conditioning raw content data, before image signal processing by an image signal processor, to generate conditioned raw content data;
compositing the conditioned raw content data with raw image data to generate composite raw image data; and
processing the composite raw image data by an image signal processing pipeline of the image signal processor.

2. The processor-implemented method of claim 1, wherein:
the raw image data comprises mosaiced raw image data; and
compositing the conditioned raw content data with the raw image data is performed before demosaicing in the image signal processing pipeline.

3. The processor-implemented method of claim 1, wherein:
conditioning the raw content data comprises modifying the raw content data based on one or more parameters associated with one or more of capture of the raw image data and the image signal processing pipeline.

4. The processor-implemented method of claim 3, wherein:
the one or more parameters comprise one or more of: a white-balance parameter, a color-correction parameter, an exposure parameter, an analog gain, a digital gain, a black-level parameter, a sensor-noise parameter, and an image signal processor tuning parameter.

5. The processor-implemented method of claim 1, wherein:
conditioning the raw content data comprises applying, to the raw content data, an inverse of at least one image-processing operation to be applied by the image signal processing pipeline.

6. The processor-implemented method of claim 5, wherein the inverse of the at least one image-processing operation comprises one or more of an inverse white-balance operation and an inverse color-correction-matrix operation.

7. The processor-implemented method of claim 1, wherein:
conditioning the raw content data comprises adding sensor-consistent noise to the raw content data before compositing the conditioned raw content data with the raw image data.

8. The processor-implemented method of claim 7, wherein:
the sensor-consistent noise is generated based on a physical noise model of an image sensor that captured the raw image data, the physical noise model including one or more of an intensity-dependent noise component and a read-noise component.

9. The processor-implemented method of claim 1, wherein:
the raw content data comprises one or more of graphical object data, logo data, virtual object data, background replacement data, inpainted region data, and outpainted region data.

10. The processor-implemented method of claim 1, wherein:
compositing the conditioned raw content data with the raw image data comprises compositing the conditioned raw content data into a target region defined by one or more of coordinates, a bounding box, a mask, a segmentation map, an object marking, and a border region of an output frame.

11. The processor-implemented method of claim 10, further comprising:
determining the target region based on a reduced-resolution image generated from the raw image data by a processing path that operates in parallel with the image signal processing pipeline.

12. The processor-implemented method of claim 11, wherein:
the processing path comprises a micro-pipe; and
determining the target region comprises tracking, using the reduced-resolution image, one or more of motion of a surface, an object, a face, a body portion, and a foreground subject across a plurality of frames.

13. The processor-implemented method of claim 1, wherein:
processing the composite raw image data by the image signal processing pipeline comprises applying temporal noise reduction to both captured-image pixels of the composite raw image data and pixels corresponding to the conditioned raw content data.

14. One or more non-transitory computer-readable media storing instructions that, when executed by one or more processors, cause the one or more processors to perform operations comprising:
conditioning raw content data, before image signal processing by an image signal processor, to generate conditioned raw content data;
compositing the conditioned raw content data with raw image data to generate composite raw image data; and
outputting the composite raw image data to the image signal processor for processing by an image signal processing pipeline of the image signal processor.

15. The one or more non-transitory computer-readable media of claim 14, wherein:
the raw image data comprises mosaiced raw image data; and
compositing the conditioned raw content data with the raw image data is performed before demosaicing in the image signal processing pipeline.

16. The one or more non-transitory computer-readable media of claim 14, wherein:
conditioning the raw content data comprises modifying the raw content data based on one or more parameters associated with one or more of capture of the raw image data and the image signal processing pipeline.

17. The one or more non-transitory computer-readable media of claim 16, wherein:
the one or more parameters comprise one or more of: a white-balance parameter, a color-correction parameter, an exposure parameter, an analog gain, a digital gain, a black-level parameter, a sensor-noise parameter, and an image signal processor tuning parameter.

18. The one or more non-transitory computer-readable media of claim 14, wherein:
conditioning the raw content data comprises applying, to the raw content data, an inverse of at least one image-processing operation to be applied by the image signal processing pipeline.

19. An image processing system, comprising:
one or more processing circuits to:
condition raw content data, before image signal processing by an image signal processor, to generate conditioned raw content data; and
composite the conditioned raw content data with raw image data to generate composite raw image data; and
an image signal processor to:
receive, from the one or more processing circuits, the composite raw image data; and
process the composite raw image data using an image signal processing pipeline of the image signal processor.

20. The image processing system of claim 19, wherein:
the raw image data comprises mosaiced raw image data; and
the one or more processing circuits are to composite the conditioned raw content data with the raw image data before demosaicing by the image signal processor.
